(19) United States
(12) Patent Application Publication
(10) Pub. No.: US 2006/0081020 A1
(43) Pub. Date: Apr. 20, 2006

(54) Anti-theft apparatus and anti-theft subject for rental or the like

(76) Inventors: Yu-Ling Hsiao, Taichung City (TW); Yueh-Ching Wu, Taichung City (TW); Yun Ju Chen, Taipei City (TW)

Correspondence Address: WENDEROTH, LIND & PONACK, L.L.P., 2033 K STREET N. W., SUITE 800, WASHINGTON, DC, 20006-1021, US

(21) Appl. No.: 11/025,141

(22) Filed: Dec. 30, 2004

(30) Foreign Application Priority Data
Oct. 20, 2004 (JP) 2004-305122
Dec. 8, 2004 (JP) 2004-355302
Oct. 29, 2004 (JP) 2004-315855

(51) Int. Cl. E05B 65/52

(52) U.S. Cl. 70/57.1; 70/63

(57) ABSTRACT

An anti-theft apparatus in which a case for an anti-theft subject is formed by a lid body coupled to a box body via a hinge. An inserting member guided by a guide provided in the case is inserted from an insertion port at a desired position of the case in order to prevent the case from being opened. The inserting member is provided with a retaining hook which is pressed back against a restoring force during insertion of the inserting member, and the case is provided with an engaging portion with which the retaining hook forms a locking relation upon complete insertion of the inserting member. A desired number of retaining hooks are provided on a line in a direction of inserting the inserting member, and the retaining hook partially employs a metal which is operable to be absorbed by a magnet. The inserting member is provided with a stopper for inhibiting the retaining hook from contacting an inner surface of the case during the disengaging procedure.

### BACKGROUND OF THE INVENTION

1. Field of the Invention

This invention relates to an anti-theft apparatus which prevents an anti-theft subject received in a case from being stolen. For example, the anti-theft apparatus prevents a disc containing recorded music and screen images received in a receiving case of a manufacturer from being stolen at a time of being displayed for rental.

2. Description of the Related Art

In the case of displaying a case which holds a disc in a shop, the receiving case is left open so as to easily pick up the disc within the receiving case. Accordingly, this results in the disc being stolen (Japanese Unexamined Patent Publication No. 10-59409 (FIG. 9)).

Therefore, the receiving case mentioned above is wrapped displayed while being wrapped by a transparent synthetic resin bag.

However, since the bag can be easily torn open, the disc within the receiving case is stolen.

Accordingly, there is a structure which intends to maintain a pressing state of an elevating body on the basis of an engagement relation between an edge of a through hole and a locking hook by pressing the elevating body serving as a lock apparatus of a display case with lock apparatus for the purpose of preventing theft, thereby inhibiting the receiving case and the enclosed disc from being picked up from the display case (Japanese Unexamined Patent Publication No. 10-250739).

However, even if it is possible to prevent the receiving case which contains the disc from being picked up from the display case while it is being displayed at a time of displaying in the shop, it is still possible to pick up the receiving case from the display case by canceling the engagement relation between the edge of the through hole and the locking hook by using a canceling device in a shop side at a time of rental, thereby lending out the selected receiving case.

Then, since an empty display case with an anti-theft function is left to be stored in the shop side, problems are encountered such as the need for arrangement of the empty cases, and the need for a wide storage place.

The receiving case is picked up from the display case mentioned above because the elevating body serving as the lock apparatus exists in the display case, and the pressing state of the elevating body is intended to be maintained on the basis of the engagement relation between the edge of the through hole and the locking hook by an erroneous pressing operation of the elevating body by a customer, whereby it is impossible to pick up the receiving case from the display case.

Accordingly, a slider is inserted into parallel engagement grooves of a box body of the case and a lid body in a case to maintain a closed state, and the slider is prevented from being pulled out from the case on the basis of an engagement relation between the slider and the case or between a locking piece constituting a locking means with the engagement groove and a locking portion in accordance with an end of the insertion, whereby the disc within the case is prevented from being picked up or being stolen at a time of displaying on the basis of this engagement relation.

On the other hand, at a time of lending out the disc, the engagement relation between the locking piece and the engagement portion is cancelled by using the canceling device in the shop side, the slider is then pulled out together with the canceling device, and the removed canceling device and slider are recovered in the shop side.

Accordingly, since the receiving case of the disc can be used as a lending case, and the closing lock means does not exist at a time of lending the case, it is possible to do away with the problems mentioned above (Japanese Patent No. 3394728).

Further, for the purpose of preventing the disc from being stolen from the receiving case (the receiving tray receiving the disc) at a time of displaying, there is a structure in which the disc receiving tray in Japanese Unexamined Patent Publication No. 7-257675 is received in a display case in a shop side.

A combined system between the display case mentioned above and the disc receiving case is structured, as shown in FIGS. 34 to 38, such that a receiving case 204 is formed by a sheet 202 having a folded bending portion 1 in a middle portion, and a tray main body 203 fixed to an inner surface of the sheet 202 at a time of bending and between an end edge of the sheet 202 and the bending portion 201 in an overlapping manner in accordance with an adhesion, and a disc 206 received in a receiving recess portion 205 of the tray main body 203 is covered by the other side of the sheet 202.

A display case 207 receiving the receiving case 204 is constituted by a box body 210 formed by a bottom wall 208, and side walls 209 and 209 continuously protruding in a direction of a back surface of the bottom wall from both side edges of the bottom wall 208, and a lid body 216 formed by an end wall 212 flexibly connected to one end edge of the bottom wall 208 via a half-cut hinge 211, a lid wall 214 flexibly connected to the end wall 212 via a half-cut hinge 213, and side walls 215 and 215 continuously protruding in a direction of a back surface of the lid wall 214 from both side edges of the lid wall 214 and covered on an outer side of the side wall 209.

The tray main body 203 is fitted to the box body 210 together with one of the sheets 202, and the other of the sheets 202 is fitted to the lid body 216, as shown in FIG. 38.

At this time, the tray main body 203 is stably received in the box body 210 by accommodating a front surface side edge of the tray main body 203 by means of a flexible accommodating piece 217 connected to an open edge of the side walls 209 and 209, and the sheet 202 is held by forming a C-shaped notch in a side edge of the lid wall 214 and inserting the side edge of the sheet 2 to a back side of a pressing piece 219 in an inner side of the notch 218.

Further, the display case 207 is maintained in a closed state by passing locking bar members 221 in both side edges of a plate-like body 220 through locking bar inserting portions 222 which are provided in a comb teeth shape so as to protrude to inner side surfaces of the side walls 209, 209, 215 and 215 of the box body 208 and the lid body 216 and are fitted in an engaging manner so as to be arranged in series, while inserting the plate-like body 220 to an inner side from matching end edges of the bottom wall 208 and the lid wall 214 after closing the display case 207 as shown in FIG. 40.

The structure is made such that a locking hook 224 of the plate-like body 220 is engaged with an inner locking portion 223 of the display case 207 under a condition that the display case 207 is maintained in the closed state, thereby preventing the plate-like body 220 from being pulled up.

In this case, the plate-like body 220 can be pulled up by disengaging the locking hook 224 from the locking portion 223 so as to cancel the engagement relation, while fitting a pin of a canceling device (not shown) in the shop side to a through hole 226 passing through the locking portion 223 and pressing back the locking hook 224 by a leading end of the pin.

In this case, since the canceling operation of recovering the slider to the shop in accordance with the structure of the Japanese Patent No. 3394728 is of the system that the locking piece comes off from the locking portion by pressing back the locking piece under the engagement relation of the locking means while inserting the canceling device into a gap, it is possible to press back the locking piece by inserting a band plate carried with the customer into the gap without using the shop's canceling device, thus canceling the engagement relation between the locking piece and the engaging portion.

Accordingly, the slider can be removed by the customer, and the disc received in the case is stolen.

Further, in the structure obtained by combining the receiving case and the display case as shown in FIGS. 37 to 41, since one sheet of the receiving case and the overlapped tray main body are prevented from being removed with respect to the box body of the display case by means of an accommodating piece, it is necessary to turn up the accommodating piece so as to fit one side of the sheet to the tray main body and to bring down the accommodating piece so as to achieve an engaging relation after fitting. Accordingly, since a significant amount of trouble is taken and the brought-down accommodating piece faces a peripheral edge portion of the received disc, it is necessary to execute a troublesome operation of turning up the accommodating piece to a collision avoiding position at a time of taking out the disc, and lowering the accommodating piece to the position under the engaging relation after fitting the disc. Because the recording surface of the disc is scratched by the accommodating piece facing the plate surface of the disc in the case, the disc is taken out from the receiving recess portion while the accommodating piece is kept as it is.

Further, the sheet and the tray main body which are fitted to the box body are slipped toward the lid body side by the sheet which is open together with the lid body in accordance with the opening of the lid body.

Accordingly, a problem is generated in that the lid body is prevented from being closed smoothly due to the tray main body slipping during the closing of the lid body and partly protruding from the box body struts.

### SUMMARY OF THE INVENTION

Accordingly, this invention makes it difficult to cancel the engagement relation of the locking means so as to prevent the disc from being stolen.

Further, in the structure obtained by combining the receiving case and the display case, it is possible to do away with the troublesome work of pressing the side edge of the sheet in the receiving case by the pressing piece and accommodating the tray main body by the accommodating piece, by only having to fit a receiving case of a manufacturer into the display case in the shop side.

In order to achieve the object as mentioned above, in accordance with the invention, a first embodiment of an anti-theft apparatus in which a receiving and display case for an anti-theft subject are contained is formed of a box body and a lid body attached at one side of the box body via a hinge so as to open and close an opening of the box body. An inserting member guided by a guide provided in the display case is inserted into an insertion port provided at a desired position of the display case. A locking means (system) for inhibiting the display case from being left open is provided in the inserting member, the box body and the lid body on the basis of a locking relation. The inserting member is provided with a locking hook (retaining hook) pressed back against a restoring force (i.e. the locking hook is resiliently biased) in accordance with the insertion of the inserting member. The display case has an engaging portion with which the locking hook engages in accordance with an end of the insertion of the inserting member. A desired number of locking hooks are provided on a line in a direction of inserting the inserting member, and the locking hook entirely or partially employs a metal which is magnetically attractable by a magnet. The inserting member is provided with a stopper for inhibiting the locking hook from being in pressure contact with an inner surface of the case due to the magnetic attraction of the locking hook during the canceling process.

A second embodiment employs an anti-theft apparatus in which a receiving and display case for an anti-theft subject is formed by a box body and a lid body provided at one side of the box body via a hinge so as to open and close an opening of the box body. An inserting member guided by a guide provided in the display case is inserted into an insertion port provided at a desired position of the display case. A locking means for inhibiting the display case from being left open is provided in the inserting member, the box body and the lid body on the basis of a locking relation. The inserting member is provided with a locking hook (retaining hook) pressed back against a restoring force (i.e. the locking hook is resiliently biased) in accordance with the insertion of the inserting member. The display case has an engaging portion with which the locking hooks engage in accordance with an end of the insertion of the inserting member. A first locking hook forms an engagement relation with a first engaging portion and is not magnetically attractable, and is provided in one of two desired surfaces in the periphery of the inserting member. A second locking hook forms an engagement relation with a second engaging portion, and is magnetically attractable, and is provided in the other desired surface of the inserting member. The display case also includes a through hole that is aligned with the second engaging portion and is shaped to allow a protruding shaft to pass therethrough for pressing back the second locking hook, thus disengaging it from the second engaging portion.

In another aspect of this embodiment, the inserting member is provided with an anti-theft tag.

A third embodiment is directed to a display system of an anti-theft subject in which an insertion port is provided at a predetermined position of an anti-theft subject receiving an article. A guide for guiding an inserting member inserted into the insertion port from a start of insertion is provided within the anti-theft subject A first locking hook (retaining hook) which is pushed back (i.e. the retaining hook is resiliently biased) in accordance with the insertion of the inserting member and is not magnetically attractable is provided in one of two desired surfaces in the periphery of the inserting member. A second locking hook which is pushed back in accordance with the insertion of the inserting member and is magnetically attractable is provided in the other desired surface of the inserting member. The anti-theft subject also has a first and second engagement portion with which the first and second locking hooks form an engagement relation in accordance with complete insertion of the inserting member. The anti-theft subject also includes a through hole that is aligned with the second engaging portion and is shaped to allow a protruding shaft of a canceling device to pass therethrough for pushing back the second locking hook, thus disengaging it from the second engaging portion. An anti-theft tag is also provided in the inserting member.

A fourth embodiment employs a structure in which a display case is formed of a first box body having an opening in a side surface, a first lid body provided at a lower side in the periphery of the box body so as to open and close the opening via a first hinge, and a lock apparatus provided at an upper side in the periphery of the lid body and the box body so as to be prevented from being unlocked in an area other than a shop, and such that a locking part is retained at the shop once the lock apparatus is unlocked. A receiving case for receiving a commodity such as a disc is formed of a second box body and a second lid body for opening and closing an opening of the second box body via a second hinge in one line in the periphery of the second box body. The cases are arranged such that when the receiving case is inserted into the display case, the hinge of the display case and the hinge of the receiving case are perpendicular to each other. In one aspect of the fourth embodiment, a structure is employed in which a fingertip fitting indentation directed toward an inner side from the opening is provided at a desired position of a peripheral wall of the box body in the display case. A slide down preventing means (slide down stopper) for preventing the receiving case from sliding down when the lid body is open is provided in the lower side in the periphery of the display case, and an anti-theft tag is provided in the locking part.

As mentioned above, in accordance with the anti-theft apparatus of the invention, since a tilt motion of the locking hook in the engagement canceling direction is stopped by the stopper when the locking hook is disengaged from the engaging portion by using the magnet, it is possible to inhibit the locking hook from being in strong pressure contact with the guide in the inner surface of the display case due to the magnetic attraction.

Accordingly, it is possible to smoothly remove the inserting member with respect to the display case.

Further, since the structure is made such as to arrange the first and second locking hooks in the inserting member which is inserted into the display case or the anti-theft subject, removing the inserting member requires inserting the protruding shaft of the canceling device into the through hole to cancel the engagement relation of the second locking hook as well as magnetically attracting the first locking hook by using the magnet to cancel the engagement relation of the first locking hook. Therefore, the canceling operation becomes complicated and an anti-theft effect can be achieved.

Further, since the anti-theft tag is provided in the inserting member which is retained at the shop side, it is possible to detect when the display case and the anti-theft subject are unfairly brought out from the shop.

Further, in accordance with the anti-theft subject for rental in accordance with the invention, since the display case is prevented from being opended by the lock apparatus while on display in the shop, it is possible to prevent the protected item contained within the display case from being removed or stolen. Since the locking part is retained in the shop when the lock apparatus is unlocked at the time of rental, the display case is not locked and does not prevent the disc from being removed or replaced even if the display case is used as a rental case. Further, since the display case is not left in the shop side, it is not necessary to store and arrange the display case which reduces the space requirements in the shop side.

Further, since the tag is provided in the locking part which is retained at to the shop side, it is not necessary to execute a shield which takes a lot of trouble at a time of being brought out from the shop.

Further, since the lock apparatus is positioned in the upper line of the display case at a time of arranging the display case on a shelf of the shop, no protrusion of the line edge toward a front side of the display case exists in a front side from the front edge of the existing shelf in the shop. In other words, the protrusion is generated by arranging the hinge in one of the lines positioned at the upper and lower sides of the display case, and arranging the lock apparatus in the other side thereof.

Accordingly, a sectional caption of a division sheet or a division plate interposed between sections of the display case is not concealed by the display case, and it is not necessary to modify the existing shelf plate.

Further, since the fingertip of the user can be caught on the side edge of the lid body of the receiving case by the defective portion (indentation) when the lid body of the display case is open, it is possible to smoothly open the lid body of the receiving case while maintaining the fitted state of the box body of the receiving case within the box body of the display case. It is also possible to prevent the box body of the receiving case from shifting with respect to the box body of the display case by the slide down preventing means (slide down stopper), and it is possible to obtain an effect of preventing the commodity received in the receiving case, for example, the disc, from being damaged. It is possible to prevent the commodity from being brought out from the shop without permission by the anti-theft tag, and the troublesome shield is not required.

### BRIEF DESCRIPTION OF THE DRAWINGS

FIG. 1 is a perspective view showing a display case in accordance with a first embodiment of the invention;

FIG. 2 is a perspective view of an inserting member and the display case;

FIG. 3 is a partly notched side elevational view of a state in which the inserting member is inserted;

FIG. 4 is a horizontally cross sectional plan view of the same;

FIG. 5 is a partly notched front elevational view of the same;

FIG. 6 is a partly notched side elevational view showing a cancellation;

FIG. 7 is a perspective view showing a display case in accordance with a second embodiment of the invention;

FIG. 8 is a perspective view of an inserting member and the display case;

FIG. 9 is a partly notched side elevational view of a state in which the inserting member is inserted;

FIG. 10 is a partly notched front elevational view of the same;

FIG. 11 is a partly notched front elevational view of the same;

FIG. 12 is a partly notched plan view of the same;

FIG. 13 is a partly notched side elevational view showing an engagement relation between a locking hook and an engaging portion;

FIG. 14 is a partly notched side elevational view showing a cancellation of the engagement relation;

FIG. 15 is a perspective view of a back surface side of the inserting member;

FIG. 16 is a perspective view of a front surface side of the other inserting member;

FIG. 17 is a back surface side perspective view of the inserting member;

FIG. 18 is a vertical cross sectional front elevational view canceling an engagement relation of a locking hook which is provided in a side surface of the inserting member and is magnetically absorbed;

FIG. 19 is a perspective view showing a fourth embodiment;

FIG. 20 is an enlarged side elevational view of the same;

FIG. 21 is a perspective view of a state in which a display case in accordance with a fifth embodiment is left open;

FIG. 22 is a perspective view of a receiving case;

FIG. 23 is a perspective view of a display case and a locking part;

FIG. 24 is a vertical cross sectional side elevational view of a locked state;

FIG. 25 is a vertical cross sectional front elevational view of the same;

FIG. 26 is a vertical cross sectional front elevational view of the display case;

FIG. 27 is a vertical cross sectional front elevational view showing an open state of a lid body;

FIG. 28 is a perspective view of a state in which the display case is left open;

FIG. 29 is a vertical cross sectional front elevational view showing positions of different hinges of the display case;

FIG. 30 is a partly notched side elevational view showing an unlocked state;

FIG. 31 is a vertical cross sectional side elevational view showing a display state;

FIG. 32 is a vertical cross sectional side elevational view showing a conventional display contrast;

FIG. 33 is a perspective view showing a slide down preventing means;

FIG. 34 is an enlarged perspective view of a main portion of a display case showing a lock apparatus in accordance with an eighth embodiment;

FIG. 35 is a perspective view showing a main portion of the lock apparatus mentioned above;

FIG. 36 is a partly notched side elevational view of the same;

FIG. 37 is an exploded perspective view of a prior article;

FIG. 38 is a perspective view showing a combination of the same;

FIG. 39 is a perspective view showing an open inhibiting portion of the display case;

FIG. 40 is a partly notched plan view of the same; and

FIG. 41 is a partly notched front elevational view of the same.

### DETAILED DESCRIPTION OF THE PREFERRED EMBODIMENTS

A description will be given of embodiments in accordance with the invention with reference to the accompanying drawings.

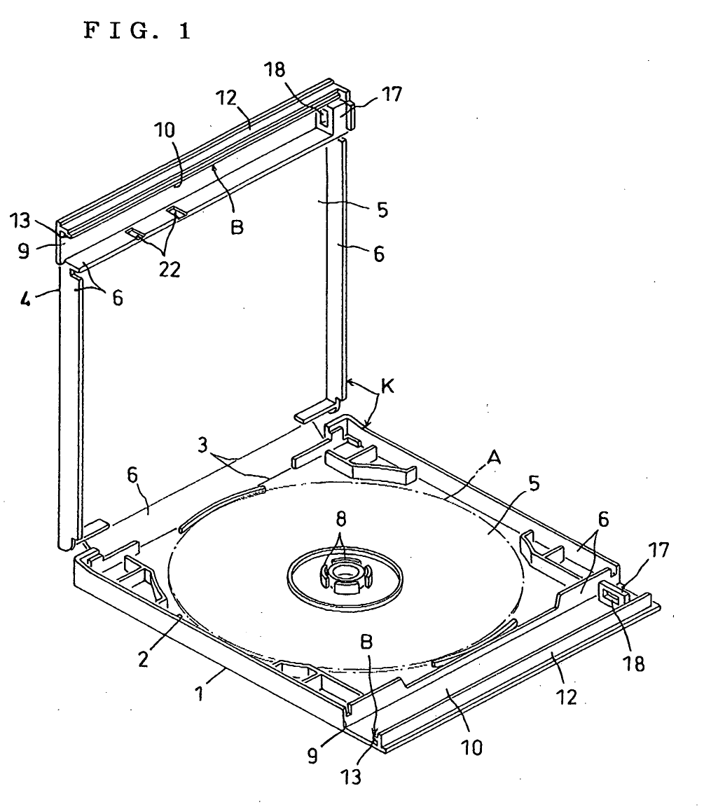

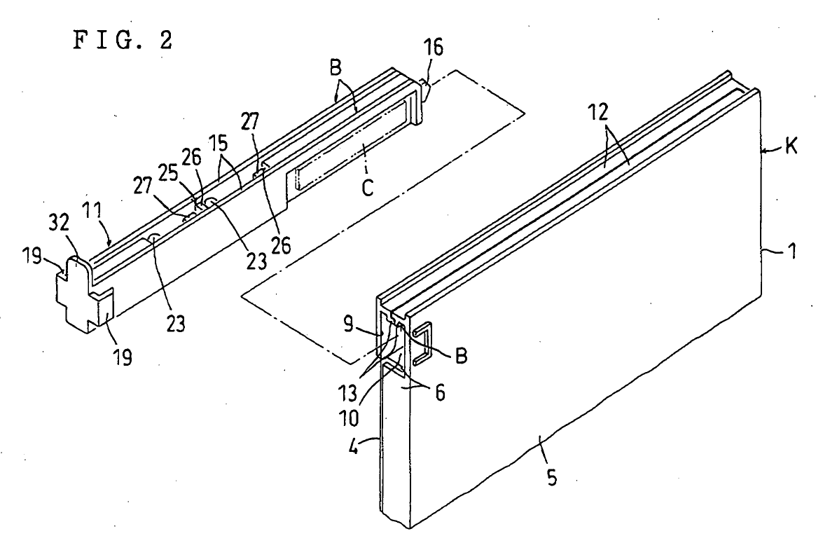

In a first embodiment in accordance with the invention, as shown in FIGS. 1 to 5, a display case K for receiving an anti-theft subject A (in this embodiment, a disc) is formed of a box body 1 and a lid body 4 attached at one side of the box body 1 via a hinge 3 so as to open and close an opening 2 of the box body 1.

The box body 1 and the lid body 4 mentioned above are structured by a main wall 5, and a peripheral wall 6 protruding from a back surface of the main wall 5 and connected to an edge of the main wall 5, in an illustrated case, and are structured such that the peripheral wall 6 of the lid body 4 is fitted to an outer side of the peripheral wall 6 of the box body 1. However, the structure may be made such that the elements are fitted in an inverse manner, or so that the open edges of the peripheral wall 6 face each other.

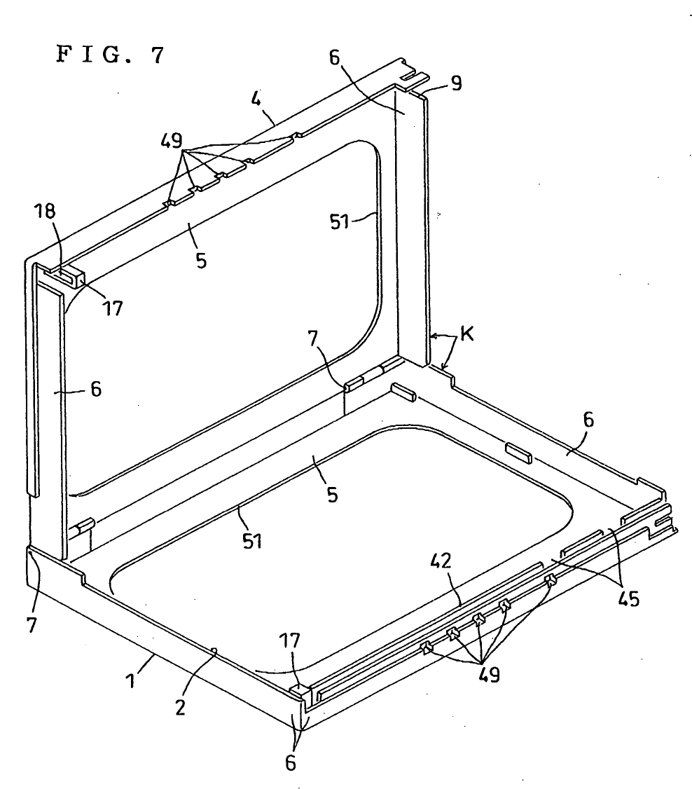

The hinge 3 mentioned above is formed by cutting off both ends of the peripheral wall 6 in one side of the box body 1 at a time of forming the display case K by a synthetic resin and arranging the double-groove half-cut hinge 3 on the boundary of the connection between both end cut-out peripheral walls 6 and the respective main walls 5 of the box body 1 and the lid body 4. However, a hinge may be formed by attaching the ends of the peripheral wall 6 in two parallel lines at both sides of the lid body 4 to the ends of the peripheral wall 6 in two parallel lines at both sides of the box body 1 via a pin as shown in FIGS. 7 and 11.

The anti-theft subject A mentioned above is shown as a disc, and a center hole of the disc is supported by a support hook 8 provided at a center of a back surface of the main wall 5 in the box body 1 so as to be received. However, other types of anti-theft subjects A may be employed in place of the disc, such as a video tape. Further, an inserting member 11 guided by a guide 10 provided in the display case K is inserted into an inserting port 9 provided at a desired position of the display case K. An engaging means B for preventing the display case K from being left open is provided in the inserting member 11, the box body 1 and the lid body 4 on the basis of an engagement relation.

The guide 10 having the inserting port 9 is structured, for example, such that a guide is formed by making the opposing edges of both the main walls 5 of the box body 1 and the lid body 4 opposite the hinge 3 protrude to an outer side from the peripheral wall 6 and making them protrude to an inner side (toward the peripheral wall 6) from each of the protruding edges so as to form a rectangular tube having the inserting port 9 in one end formed by L-shaped connection walls 12 facing each other when the display case K is closed and the peripheral wall 6. However, the guide is not limited to an outer side of the peripheral wall 6, and an inserting guide for the inserting member 11 may be formed by arranging the inserting port 9 in the peripheral wall 6 so as to be positioned in an inner side of the peripheral wall 6, and by arranging a protrusion for a rail in the back surfaces of both the main walls 5 of the box body 1 and the lid body 4 (both are omitted in illustration).

The guide is not limited to the structure mentioned above, and may be constituted by other structures as long as the structure guides the insertion of the inserting member 11.

Further, the position at which the guide 10 is provided is not limited to the illustrated edge which is parallel to the hinge 3, and the guide having the inserting port may be provided in a line in the end side of the hinge 3 of the display case K.

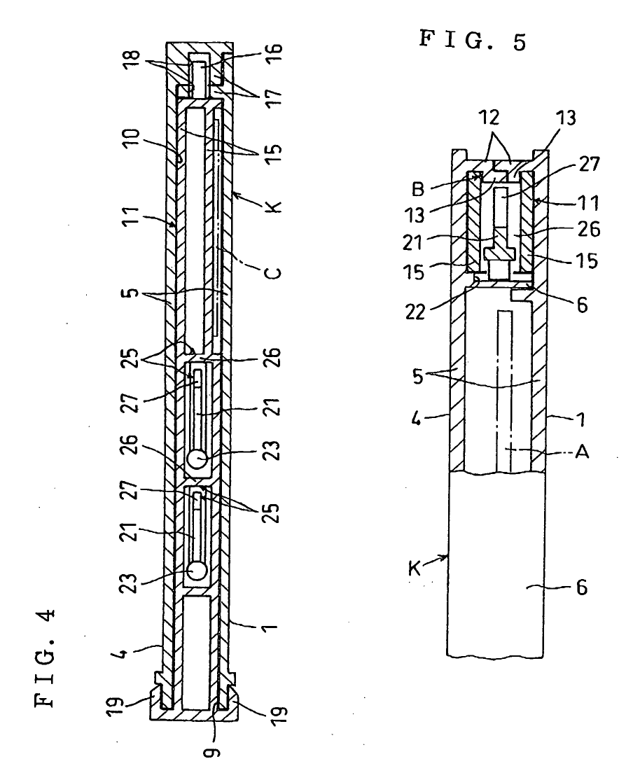

The engaging means B mentioned above is structured such that a protruding portion 13 protruding toward the inserting member 11 is provided in both the connection walls 12 in the illustrated case. Both the protruding grooves 13 are accommodated as shown in FIG. 5 by a connection plate of the inserting member 11, and by edges of both side plates 15 connected in an H-shaped vertical cross sectional shape from both side edges of the connection plate 14 the insertion of the inserting member 11. The inserting member 11, the box body 1 and the lid body 4 are in an engagement relation so as to prevent the display case K from being opened. However, the inserting member 11 inserted by another engaging means B may also serve as a key so as to prevent the display case K from being opened.

In short, the engaging means is not limited to the structure mentioned above, and the structure may be made as long as the box body 1 side and the lid body 4 side form the engagement relation with respect to the inserting member 11 by inserting the inserting member 11 on the basis of the other structures so as to maintain the closed state.

In this case, as shown in FIG. 4, in the case of passing and fitting a protruding piece 16 protruding from a leading end of an insertion front end of the inserting member 11 through a hole 18 of a protruding portion 17 of the box body 1 and the lid body 4, or bringing accommodating pieces 19 in both sides of a terminal end of the inserting member 11 into outer contact with the main wall 5 of the box body 1 and the lid body 4, the inserting member 11 serves as a locking bar at a time of finishing the insertion of the inserting member 11. It is then possible to maintain a closed state of the display case K even if a force in an open direction is applied to the display case K.

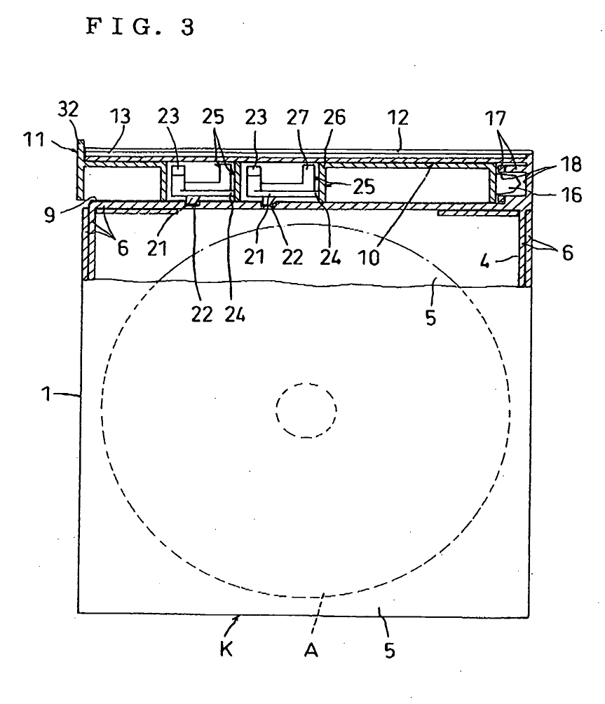

Further, the inserting member 11 is provided with a desired number of locking hooks 21 (retaining hooks) which are in contact with the guide 10 in accordance with the insertion of the inserting member 11 so as to be pressed back against a restoring force (i.e., the locking hooks 21 are resiliently biased). The display case K is provided with engaging portions 22 which prevent the inserting member 11 from being pulled out due to an engagement relation with the locking hooks 21 which are returned by the pressing back force (i.e., resiliently) at the end of insertion of the inserting member 11, as shown in FIG. 3.

Further, there is employed a metal which magnetically attracts an entire or a part of the locking hook 21 by magnetic force and cancels the engagement relation of the locking hook 21 with the engaging portion 22.

Since the locking hook 21 mentioned above is structured, in the illustrated case, such that the inserting member 11 with the locking hook 21 is integrally formed by a synthetic resin (i.e., a main body of the locking hook is one-piece with the inserting member), an iron piece 23 is fixed to a tilt free end (i.e., the distal end opposite the terminal end pivotally connected to the inserting member) of the locking hook 21 in accordance with a screwing, a fitting system, an adhesive agent or the like. However, the terminal end of the metal locking hook can be attached to the inserting member.

A tilt motion (pivot) supporting point (i.e., terminal end) 24 of the locking hook 21 with the iron piece 23 forms a portion connected to the inserting member 11 in accordance with an integral molding, and the tilt motion supporting point of the metal locking hook has a thickness such that the supporting point can be bent in a front side of the mounting portion. Taking the above matters into consideration, and for the purpose of an automatic engagement in accordance with the alignment of the hook portion of the locking hook 21 with the engaging portion 22, an angle is determined such that the restoring force is applied to the locking hook 21 due to a pressing back force (i.e., resiliency force) generated by the contact between the guide 10 and a tilt motion free end (distal end) of the locking hook 21 during the insertion of the inserting member 11 at a time of the integral molding and the mounting.

Further, in the illustrated case, the locking hook 21 and the engaging portion 22 are arranged at two points in the front and rear sides on the inserting line of the inserting member 11. However, the number is not limited, and may be approximately determined. Further, they may be arranged along a straight line or in a zigzag manner in right and left sides of the straight line.

Accordingly, it is possible to prevent the display case K from being left open by the inserting member 11 so as to prevent the anti-theft subject A from being stolen.

Further, the structure is made such that a stopper 25 prevents the locking hook 21 from being in pressure contact with the inner surface of the guide 10 of the display case K when the iron piece 23 is magnetically attracted by the magnet 31 of the canceling device D in the shop side (outside the display case) thereby canceling the engagement relation of the locking hook 21 with respect to the engaging portion 22.

The stopper 25 mentioned above is structured, in the illustrated case, such that a wall 26 integrally provided within the inserting member 11 in accordance with a molding, and a protruding portion 27 in the tilt motion supporting end (terminal end) 24 of the locking hook 21 are brought into contact with each other, thus preventing any further motion. The same purpose can be achieved by bringing a middle of the locking hook 21 into contact with a lever (not shown), for example, horizontally provided within the inserting member 11.

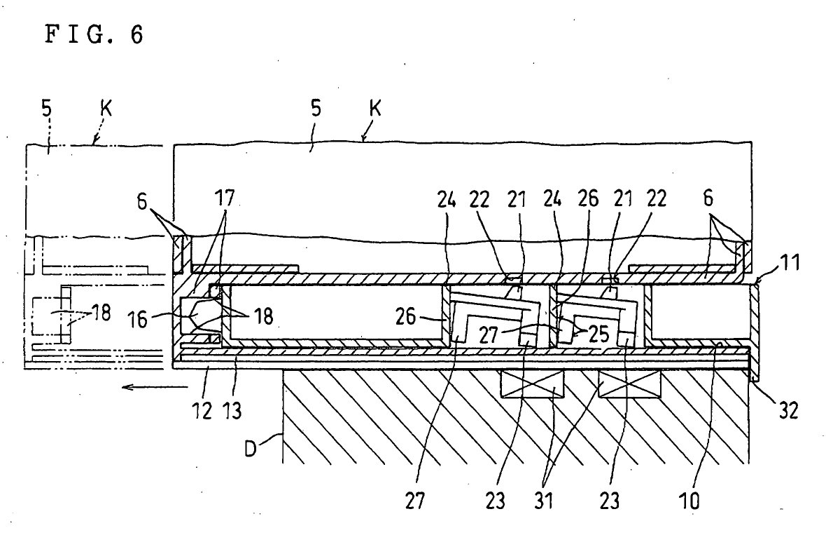

Accordingly, the iron piece 23 is magnetically attracted by the magnet 31 of the canceling device D as shown in FIG. 6, which cancels the engagement relation between the engaging portion 22 and the locking hook 21.

At this time, it is possible to prevent the locking hook 21 magnetically attracted by the stopper 25 from being in pressure contact with the inner side of the guide 10.

Under this condition, the inserting member 11 can be withdrawn from the display case K on the basis of the catch (engagement) between the canceling device D and the protruding piece 32 of the inserting member 11, by sliding the display case K in a leftward direction shown by an arrow in FIG. 6 or sliding the canceling device D in a rightward direction in FIG. 6.

Since the pressure contact of the locking hook 21 does not exist at the time the inserting member 11 is withdrawn a frictional resistance due to the pressure contact with an inner wall of guide 10 does not exist, so that the inserting member 11 can be smoothly withdrawn.

The withdrawn inserting member 11 is retained at the shop side so as to be reused, and the display case K from which the inserting member 11 is recovered is used as the rental case or the sale case.

At this time, since no inserting member 11 exists in the case, the case can be freely opened and closed.

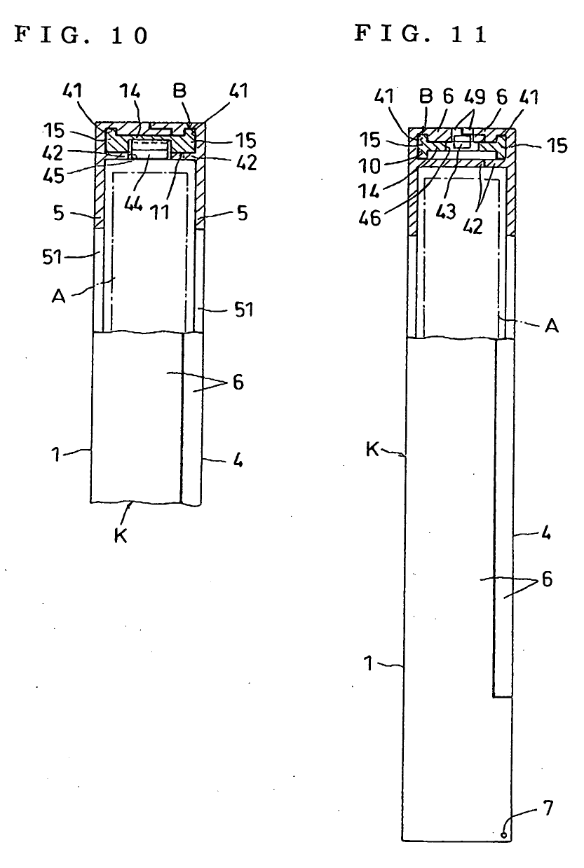

In accordance with a second embodiment of the invention, as shown in FIGS. 7 to 13, the display case K receiving the anti-theft subject A is formed by the box body 1, and the lid body 4 provided at one side of the box body 1 via a hinge 7 so as to open and close the opening 2 of the box body 1.

The hinge mentioned above is shown as a pin 7 hinge in FIG. 7. However, the same half-cut hinge in accordance with the first embodiment may be employed.

The anti-theft subject A mentioned above is constituted by the receiving case receiving the disc in the illustrated case. However, the subject may be constituted only by the disc in the same manner as the first embodiment. Articles other than a disc may also be used as the anti-theft subject.

Since the structure of the display case K mentioned above is the same as the first embodiment, a description thereof will be omitted.

Further, an engaging means B for inhibiting the display case K from being left open is provided on the basis of the engagement relation between the inserting member 11, the box body 1 and the lid body 4. The inserting member 11 guided by the guide 10 provided in the display case K is inserted from the inserting port 9 provided at a desired position of the display case K.

The engaging means B mentioned above is structured such that the upper edges of both side plates 15 of the inserting member 11 are fitted in an engaging manner to grooves 41 in a longitudinal direction on the inner surfaces of both the peripheral walls 6 in which the open edges face each other. The inserting member 11, serving as a key, prevents the box body 1 and the lid body 4 from being opened. However, the structure is not limited to this.

The structure is not limited to the illustrated structure, and may be made in other ways as long as the box body 1 side and the lid body 4 side form the engagement relation with respect to the inserting member 11 so as to maintain the closed state.

Since the structure of the inserting member 11 mentioned above is the same as the first embodiment, a description thereof will be omitted.

Further, the guide 10 is structured such that the peripheral wall 6 is provided with guide walls 42 which are in parallel with a predetermined interval in a back surface side of the peripheral wall 6 from the main walls 5 of the box body 1 and the lid body 4. An interval between the guide walls 42 and the peripheral walls 6 is formed as the guide 10. However, the inserting port 9 in accordance with the second embodiment is not limited, but can employ, for example, the same guide 10 as that of the first embodiment.

In this case, as shown in FIGS. 7, 10 and 11, a reentrant step portion is provided in an inner surface of one of the open edges of the peripheral wall 6 opposing the pin 7 of the hinge in the box body 1 and the lid body 4, and a protruding step portion is provided in an outer surface of the other. Thus, the open edges confront each other in a fitting manner. However, the structure is not limited to this, and may be made in the same manner as the first embodiment, such that the protruding piece 16 is provided in a leading end in an inserting direction side of the inserting member 11, the protruding portion 17 having the hole 18 is provided in the display case K side, and the protruding piece 16 is passed through the hole 18, whereby it is possible to prevent the display case K from being opened due to the force application in the opening direction.

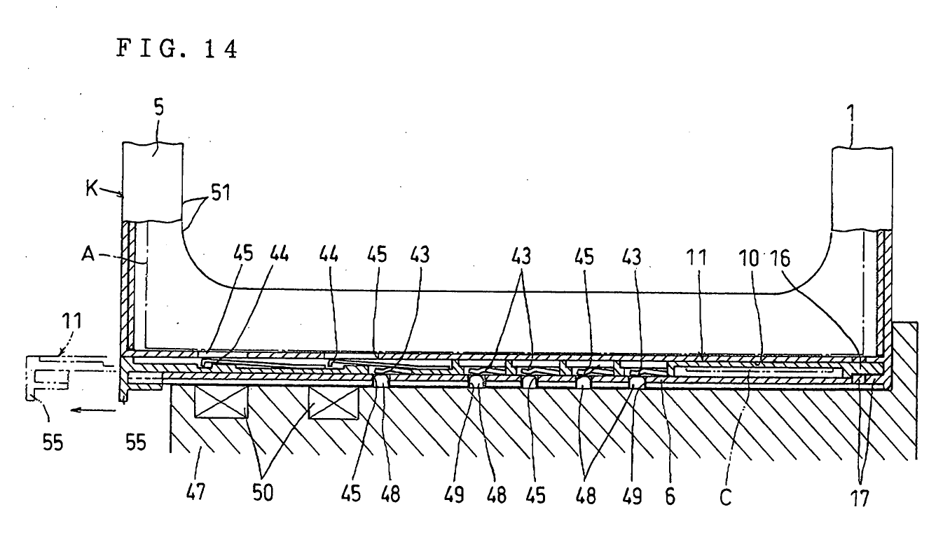

Further, the inserting member 11 is provided with a desired number of locking hooks 43 which are in contact with the guide 10 during the insertion of the inserting member 11. The locking hooks 43 are pressed back against the restoring force (i.e., are resiliently biased) and are made of material which is not magnetically attracted. The inserting member 11 is also provided with a desired number of locking hooks 44, made of material which is magnetically attracted, along the line in the inserting direction. The guide 10 is provided with an engaging portion 45 which prevents the inserting member 11 from being taken out once an engagement relation is formed between the locking hooks 43, 44 and the engagement portion 45. The engagement relation is formed when each of the locking hooks 43 and 44 are restored by the pressing back force (resiliency) after complete insertion of the inserting member 11, as shown in FIG. 13.

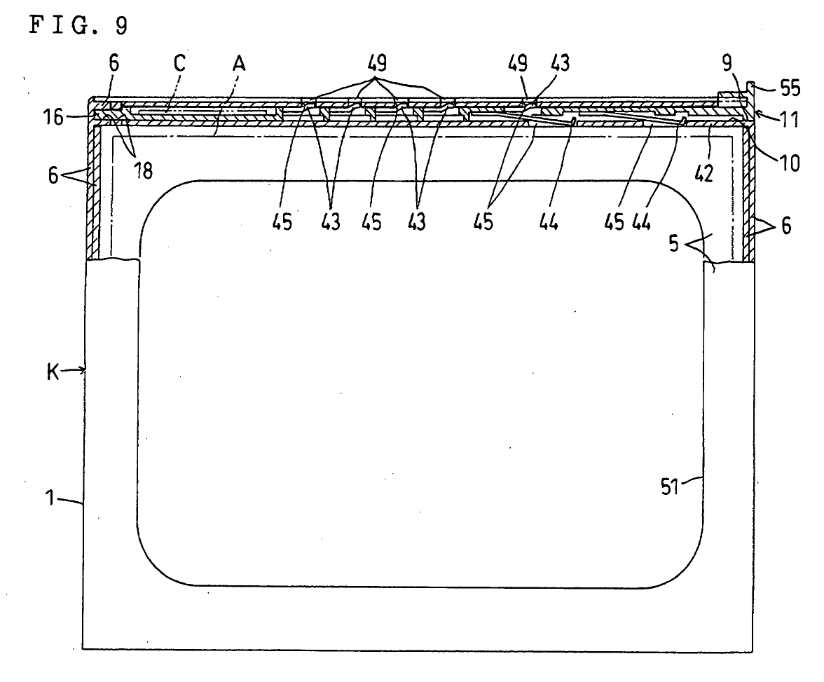

Several locking hooks 43 are provided in the front and rear sides, and two locking hooks 44 are provided in the front and rear sides in the case of FIG. 9, while only one locking hook 44 is provided in the case of FIG. 13. However, the number is freely determined, and may be appropriately determined for the purpose of making the process of removing the inserting member 11 more complex.

Further, the engaging portion 45 is magnetically attracted to the peripheral wall 6 side of the guide 10 by using the magnet in the locking hook 43 side, and is magnetically attracted in the front surface side of the peripheral wall 6 by using the magnet, in the locking hook 44 side. Therefore, the engaging portion 45 is provided in the guide wall 42.

The locking hook 43 which is not magnetically attracted, is integrally formed at a time of molding the inserting member 11 made of the synthetic resin, and is provided in an inner side of a C-shaped slit 46 so as to protrude in a back surface direction of the peripheral wall 6. However, a terminal end of the locking hook 43 constituted by the other part made of material which is not magnetically attracted may be firmly attached to the inserting member 11.

The locking hook 44 which is magnetically attracted by the magnet is provided by forming an iron piece made of metal, and is firmly attached at the terminal end of the locking piece 44 to the inserting member 11 by an adhesive agent, a caulking pin or the like.

Further, the portion of wall 6 aligning with the free end portion of the locking hook 43 is provided with a through hole 49 through which a protruding shaft 48 for pressing back the locking hook 43 of a canceling device 47 passes. The canceling device 47 is also provided with a magnet 50 for magnetically attracting the locking hook 44 to the canceling device 47.

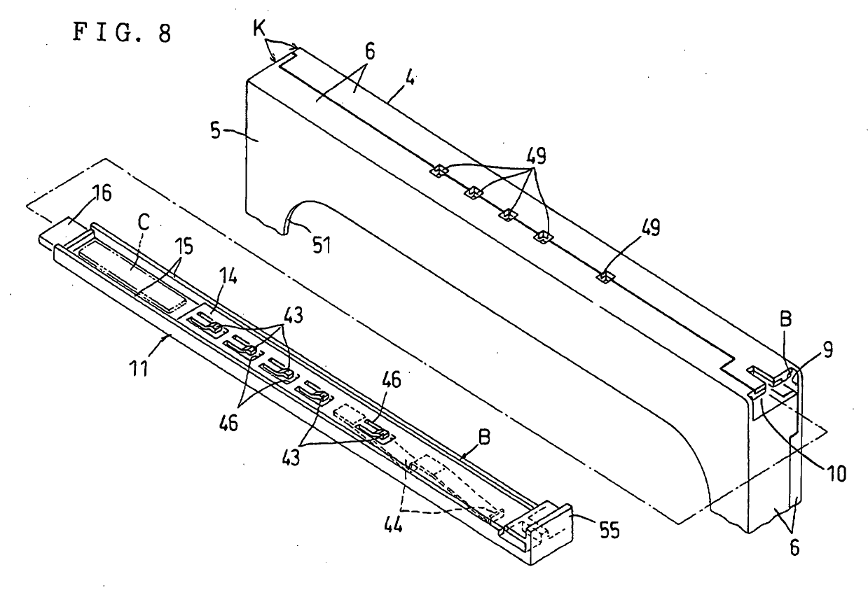

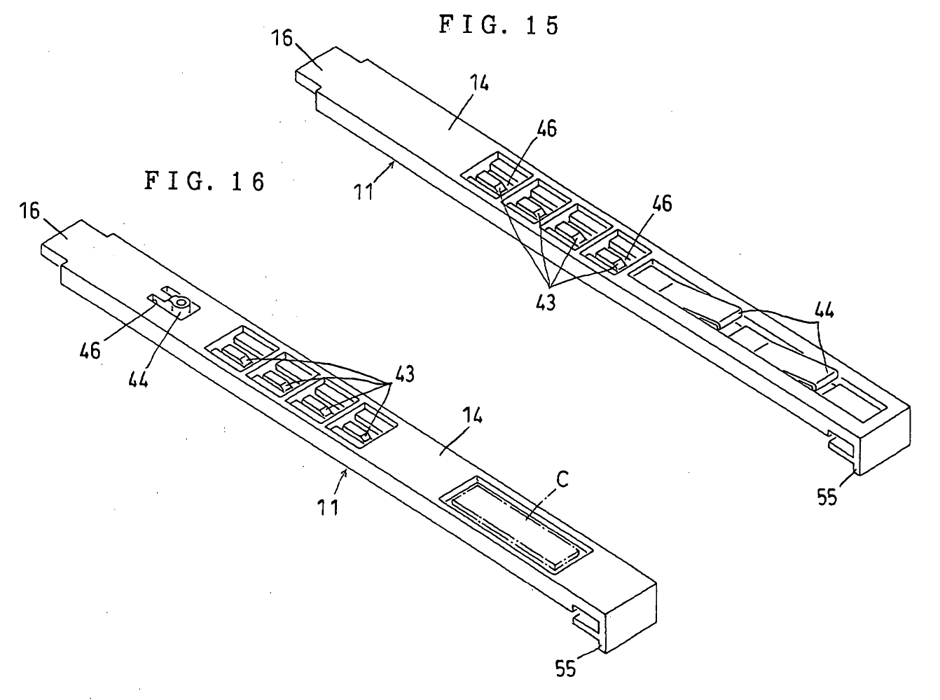

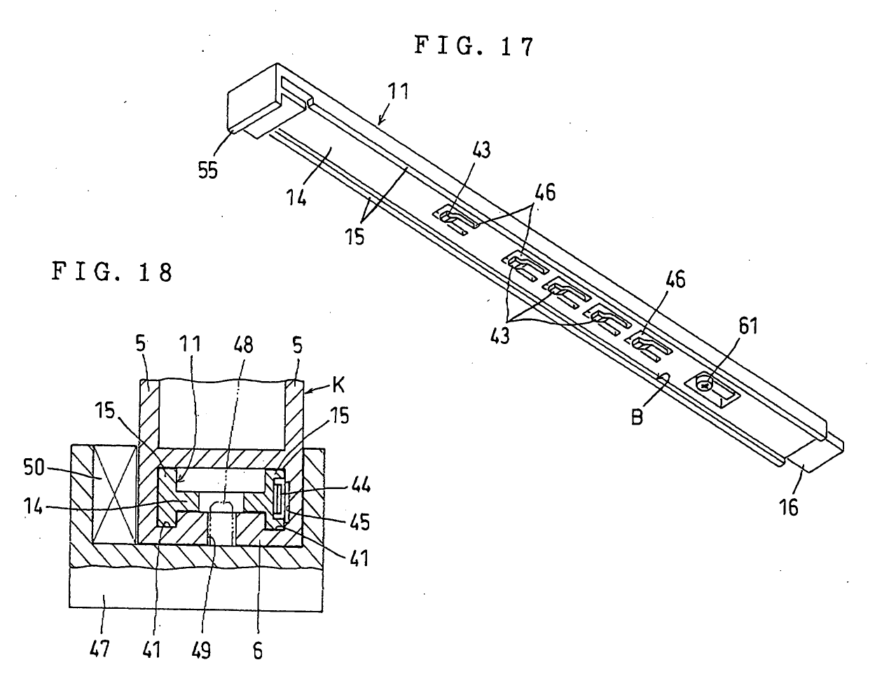

In other words, the locking hook 43 is provided in a front surface side opposing the back surface of the peripheral wall 6 in the inserting member 11 (refer to FIGS. 8, 9, 11 and 12). The locking hook 44 is provided at a back surface side of the inserting member 11 (refer to FIGS. 8, 10 and 15), and the locking hooks 43 and 44 are structured, as shown in FIGS. 16 and 17, such that a slit 46 is formed in the inserting member 11 made of synthetic resin. The locking hook 43 protrudes from the front surface side of the inserting member 11, and the locking hook 44 protrudes from the back surface side of the inserting member 11. The hooks provided in an inner side of the slit 46, and hook 44 may be formed by screwing a metal screw 61 magnetically absorbed to the free end side of the locking hook 44, or attaching the metal piece by an adhesive agent or the like.

Further, the magnetically attracted locking hook 44 may be provided in one side surface of the inserting member 11 in place of the back surface of the inserting member 11.

In the drawing, reference numeral 51 denotes a through window provided in the main wall 5.

In accordance with the structure mentioned above, the inserting member 11 is inserted from the inserting port 9 while being guided by the guide 10. Each of the locking hooks 43 and 44 engages each of the respective locking portions 45 after complete insertion of the inserting member 11 as shown in FIG. 13. The inserting member 11 is prevented from being removed from the display case K, and the display case K is prevented from being opened under this condition. The anti-theft subject A within the display case K is thus prevented from being stolen.

A description will now be given of a canceling method.

As shown in FIG. 14, the protruding shaft 48 of the shop side canceling device 47 is fitted into each of the through holes 49.

Then, all the locking hooks 43 are pressed back by the protruding shaft 48, and the engagement relation between the locking hook 43 and the engaging portion 45 is cancelled.

Further, as shown in FIG. 14, since the locking hook 44 is magnetically attracted by the magnet 50 of the canceling device 47 aligning with the locking hook 44, the engagement relation between the engaging portion 45 and the locking hook 44 is cancelled while drawing back the locking hook 44.

Next, the fingertip of the user is caught on a piece 55 on a terminal end of the inserting member 11 so as to withdrawn the inserting member 11, and the withdrawn inserting member 11 is retained at the shop side.

Then, the display case K is used as the rental case or the sale case.

Since no inserting member 11 remains in the display case K, the display case K can be freely opened and closed at a time of rental or sale.

Since the locking hook 43 which is not magnetically attracted and the locking hook 44 which is magnetically attracted by the magnet are used together, the engagement relation can not be canceled due to the existence of the locking hook 44 under the concealed state, even if the engagement relation can be canceled by the customer by inserting a shaft into each of the through holes 49 so as to press back the locking hook 43. In other words, it solves the problems caused by the independent locking hook which is not magnetically attractable and the independent locking hook which is magnetically attractable.

Further, the difficulty of withdrawing the inserting member 11 is increased by changing the arrangement of the magnetically attracted locking hook 44.

In the case of arranging the magnetically attractable locking hook 44 at the side surface of one of the inserting members 11, the locking hook 44 is cancelled by magnetically attracting the locking hook 44 with the magnet 50, which is arranged in the opposite side surface of the locking hook 44 in the canceling device 47, as shown in FIG. 18.

Accordingly, the leading end of the locking hook 44 is retracted from the engaging portion 45, and the engagement relation between the engaging portion 45 and the locking hook 44 is canceled.

The locking hook 43 is simultaneously pressed back by the protruding shaft 48, whereby the engagement relation between the locking hook 43 and the engaging portion 45 is canceled.

In accordance with a third embodiment of the invention, the anti-theft tag C is provided in the inserting member 11 in accordance with the first and second embodiments.

The tag C has, for example, a specific ID code, and is structured such that when passing through an entrance of the shop, a resonance circuit resonates on the basis of the generation of a high-frequency electromagnetic field placed at the entrance and the high-frequency electromagnetic field is modulated in accordance with a transmission of the specific ID code, thereby detecting when the tag is brought out of the shop.

Accordingly, it is possible to prevent the display case K, which is displayed in the shop in the locked condition, from being brought out, and it is not necessary to execute troublesome shielding work of the display case K after the inserting member 11 is recovered to the shop side.

In this case, the guide 10 is provided in the outer side of the peripheral wall 6 in accordance with the first embodiment, and the guide 10 is provided in the inner side of the peripheral wall 6 in accordance with the second embodiment. However, the guide is not limited to this specific arrangement, and may be provided in the inner side and the outer side of the peripheral wall 6 in any way.

Further, the display case K includes the box body 1 with the engaging means B and the lid body 4 for maintaining the closed state in accordance with the insertion of the guide 10 and the inserting member 11.

Further, the peripheral wall 6 of the box body 1 and the lid body 4 are provided along the entire length of the line edges, but may be provided only along the necessary portions of the line edges. For example, the peripheral wall 6 may be provided only in the corner portions and not along the intermediate portions, or may be provided only along the necessary lines.

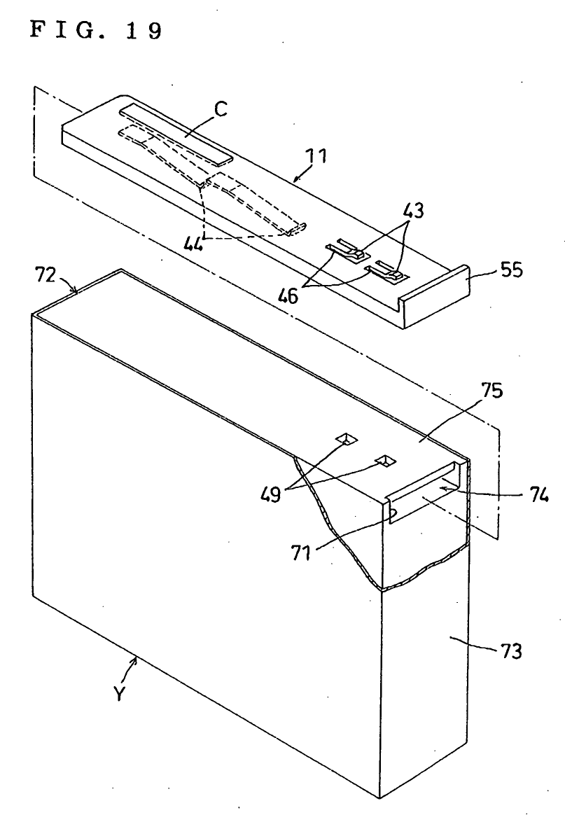

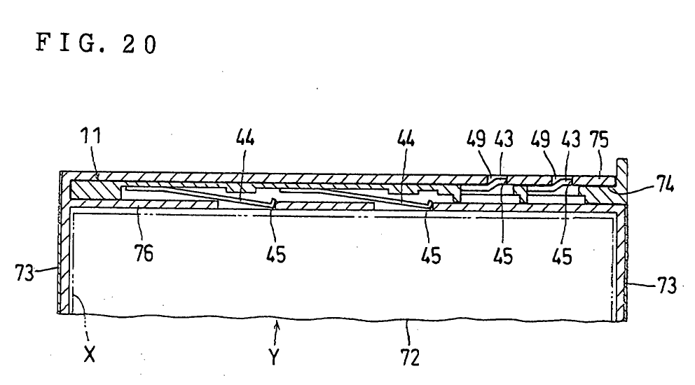

In accordance with a fourth embodiment of the invention, as shown in FIGS. 19 and 20, an inserting port 71 is provided at a predetermined position of an anti-theft subject Y which recieves an article X of a display system of an anti-theft subject.

The anti-theft subject Y mentioned above is shown as the anti-theft subject in which the article X is received in a case 72. An outer side of the case 72 is covered with a transparent synthetic resin cover 73, and an inserting port 71 is aligned with the case 72 and the cover 73 in the illustrated case. However, the anti-theft subject is not limited to this, but it is possible to apply to a structure obtained by combining a blister pack system board and a cover obtained by forming a plastic in correspondence to a shape of the article. The anti-theft subject can also apply to a skin package system, a strip package system, a package system constituted by the normal box body and lid body and covering an outer side thereof with a heat shrinkable film so as to make it hard to take out the received article at a time of displaying, and other package systems (since all of them are known, an illustration thereof will be omitted). In short, the anti-theft subject is the article (commodity) intended to be prevented from being stolen from the display in the shop, or another packaged article shipped from the manufacturer or a similar packaged article such as the article which is not packaged and received in the prepared rental case in the rental shop or the like so as to be lent.

Further, in the case that the cover and the film are provided, the inserting port 71 is provided in the cover and the film.

Reference numeral 11 denotes an inserting member to be inserted into the inserting port 71.

Reference numeral 74 denotes a guide for the inserting member 11 provided within the anti-theft subject Y.

The guide 74 mentioned above is structured, in the illustrated case, such as to form a rectangular tubular space by an upper peripheral wall 75 of the case 72, which is capable of having the inserting member 11 inserted therein. A guiding wall 76 is provided within the case 72 so as to oppose the wall 75 and both sidewalls of the case 72, thereby guiding the inserting member 11 from the start of insertion. However, the guide 74 is not limited to the structure mentioned above, but may be structured such as to guide the inserting member 11 in accordance with other structures.

Further, an upper surface in the drawing (a surface opposing to the wall 75) of the inserting member 11 is provided with the locking hook 43 which is not magnetically attractable and is in contact with the inner surface of the wall 75 in accordance with the insertion of the inserting member 11 so as to be pressed back. The locking hook 43 is fitted to the engaging portion 45 provided in the inner wall of the wall 75 in accordance with complete insertion of the inserting member 11 so as to form an engagement relation, and prevents the inserting member 11 from being withdrawn. A lower surface (a surface opposing to the wall 76) of the inserting member 11, or a side surface of the inserting member 11 is provided with the magnetically attractable locking hook 44 which is pressed back in accordance with the insertion of the inserting member 11. The magnetically attractable locking hook 44 is fitted with the engaging portion 45 provided in a surface (the wall 76 in the illustrated case) of the guide 74 in accordance with complete insertion so as to form the engagement relation, and prevents the inserting member 11 from being withdrawn.

Accordingly, the inserting member 11 inserted in the shop side is prevented from being taken out by the customer.

Further, the anti-theft tag C is provided in the inserting member 11, whereby it is possible to prevent the anti-theft subject Y from being brought out from the shop by the customer.

Since the locking piece 43 which is not magnetically attractable, the locking hook 44 which is magnetically attractable, and the engaging portion 45 are the same as those of the second embodiment, and the anti-theft tag C is the same as the third embodiment, a description of the structure and the operation and effect will be omitted.

Since the engagement relation is canceled by using the protruding shaft 48 together with the magnet 50 on the locking hooks 43 and 44 with respect to the engaging portion 45 in accordance with the removal of the inserting member 11 in the shop side in the same manner as the second embodiment, a description thereof will be omitted.

Further, the wall 75, which has the engaging portion 45 of the case 72 of the anti-theft subject Y, is provided with a through hole 49 which is shaped to receive the protruding shaft 48 of the canceling device 47 at a position aligned with the engaging portion 45 in the inner surface from the outer surface of the wall 75 so as to press back the locking piece 43, and cancels the engagement relation between the engaging portion 74 and the locking hook 43 on the basis of the pressing back of the locking hook 43.

In this case, the withdrawn inserting member 11 is retained at the shop side so as to be reused.

As mentioned above, on the basis of the combination between the locking piece 43 which is not magnetically attractable, and the locking piece 44 which is magnetically attractable, the specific effect can be achieved in the same manner as the second embodiment.

Since the locking hook 43, which is not magnetically attractable, and the locking hook 44 which is magnetically attracted by the magnet 50 are used together, the engagement relation can not be canceled due to the existence of the canceled locking hook 44 even if the engagement relation of the locking hook 43 can be canceled by the customer by inserting a shaft into each of the through holes 49 so as to press back the locking hook 43.

Further, the difficulty of withdrawing the inserting member 11 is increased, and is further increased on the basis of the number and the arrangement of the locking hook 44.

In this case, the locking hook 43 which is not magnetically attractable and the locking hook 44 which is magnetically attractable are provided in the front surface and the back surface of the inserting member 11 or the front surface and one side surface in the embodiment. However, the locking hook 43 which is not magnetically attractable may be provided in one side surface of the inserting member 11, and the locking hook 44 which is magnetically attractable may be provided in the other side surface (not shown).

In the event that the locking hook 43 which is not magnetically attractable is provided in the side surface of the inserting member 11 the through hole 49 is provided in the wall opposing the locking hook 43 (not shown).

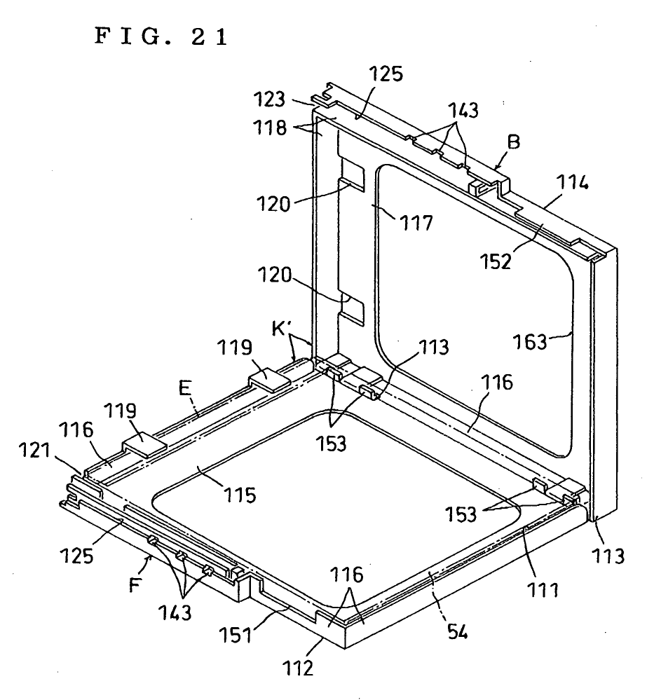

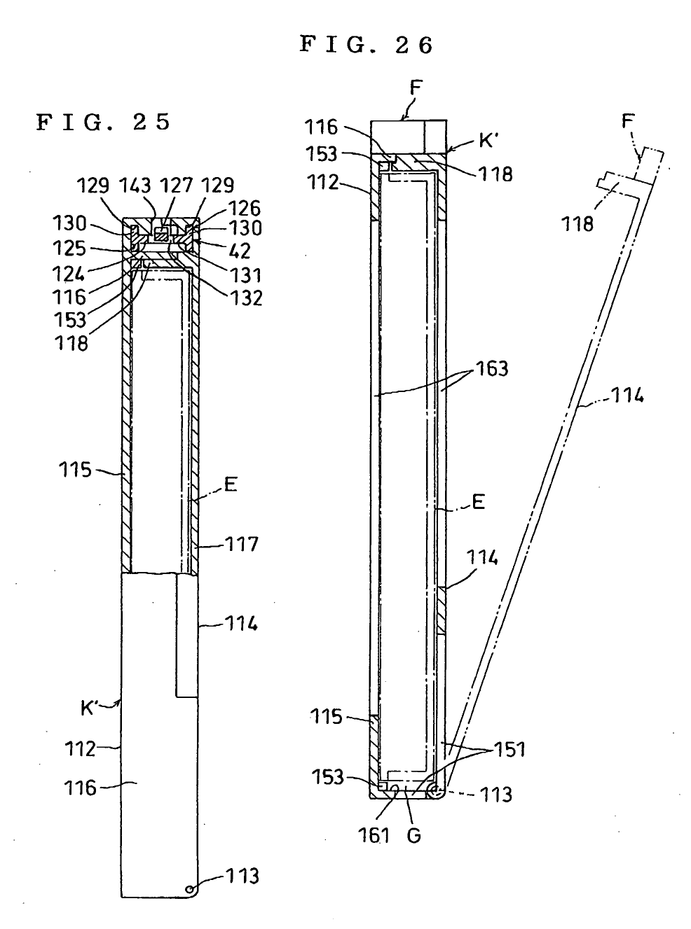

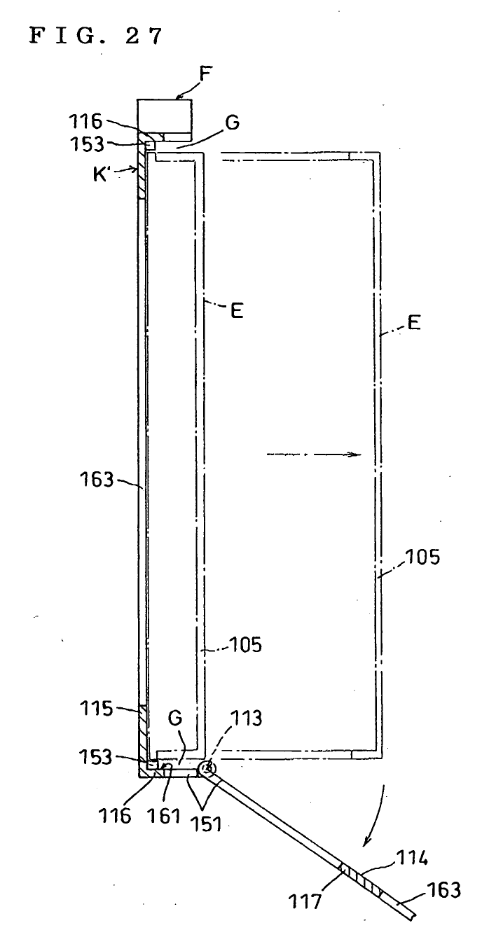

In accordance with a fifth embodiment of the invention, as shown in FIGS. 21 to 29, a display case K′ is formed by a box body 112 having an opening 111 in a side surface, a lid body 114 provided in a lower line side in the periphery of the box body 112 so as to open and close the opening 111 via a hinge 113, and a lock apparatus F which can not be unlocked in a place other than the shop. The lock apparatus F is provided at an upper side of the lid body 114 and the box body 112, and includes a removable locking part 101 which remains in the shop when the case in unlocked.

The box body 112 structuring the display case K′ is constituted by a side wall 115 and a peripheral wall 116 connected to an edge of the side wall 115 and protrudes towards a back surface of the sidewall 115. However, the box body is not limited to the structure mentioned above, but may be structured such that the peripheral wall 116 protrudes, for example, only from a desired line edge of the side wall 115, or from a predetermined portion of the line edge, for example, from a corner, an intermediate portion or the like.

Further, the lid body 114 is structured such as to be provided with a peripheral wall 118 connected only to an edge of the lock apparatus F side of a side wall 117, or to each of the edges of the sidewall 117 and protrudes towards a back surface. The lid body 114 may protrude only from a desired edge, or from a predetermined portion of the edge, for example, from a corner portion, an intermediate portion or the like.

The hinge 113 of the lid body 114 provided in the box body 112 structuring the display case K′ is structured, as shown in FIGS. 21, 23, 28 and 33, such that the peripheral wall 116 is not provided along one edge of the side wall 115 of the box body 112. An open edge of the peripheral wall 118 along one line of the lid body 114 is attached to the edge of the sidewall 115 having no peripheral wall 116 by the pin hinge 113 so as to be freely opened and closed, and the peripheral wall 118 is covered on the outer side of the peripheral wall 116.

Further, the hinge 113 mentioned above is structured such that the edge of the side wall 117 is attached to the peripheral wall 116 forming the lower line via the pin hinge at a time of being displayed in the illustrated case. However, the display case is not limited to this, and may employ a half-cut hinge.

Further, the half-cut hinge may be constituted, for example, by one groove of the connection portion between the peripheral wall 116 and the side wall 117, two grooves of the connected portions between the peripheral wall 116 having cut-out both ends and the side walls 115 and 117, or the like.

The lock apparatus F mentioned above is constituted, for example, in the case shown in FIGS. 21 to 25, by a guide 125 which guides an inserting member 124 serving as the locking part 101 inserted into an inserting port 123. The inserting member 124 includes a locking hook 127 (retaining hook) to maintain a closed state of the display case K′ on the basis with an engagement relation of an engaging portion 126 between the inserting member 124 and the display case K′. The locking hook 127, which is not magnetically attractable, is pressed back against a restoring force (i.e., the locking hook 127 is resiliently biased) in accordance with insertion of the inserting member 124. A locking hook 133 (retaining hook), which is magnetically attractable, is pressed back against a restoring force (i.e., the locking hook 133 is resiliently biased) in accordance with the insertion of the inserting member 124. An engaging portion 128 is provided within the guide 125 such that the locking hooks 127 and 133 form an engagement relation (for preventing the inserting member 124 from being taken out by the customer) in accordance with complete insertion of the inserting member 124. However, it is possible to use the lock apparatus of the other structures mentioned above to achieve this purpose.

Further, the engaging portion 126 is structured, in the case shown in the drawing, such as to be provided with parallel T-shaped engaging grooves 129 positioned in along an upper side of the peripheral walls 116 and 118 so as to be connected to upper edges of both the side walls 115 and 117. The engaging portion 126 is structured to fit both side plates 130 of the inserting member 124 inserted to both the engaging grooves 129, and is intended to maintain a closed state between the box body 112 and the lid body 114 on the basis of the engagement. However, the structure is not limited to this, but it is possible to employ an engaging portion having another structure and the same purpose.

Further, a space surrounded by the parallel engaging grooves 129 and the peripheral walls 116 and 118 is formed due to the guide 125 having the inserting port 123 in one end. However, the structure is not limited to this, but may be made such that the parallel engaging grooves 129 are provided on an inner side of the facing edges of both the peripheral walls 116 and 118. The protruding wall (not shown) is provided on the inner sides of both the peripheral walls 116 and 118, and on the inner surfaces of both the side walls 115 and 117 so as to be parallel to the inner sides of both the peripheral walls 116 and 118. The guide also has the inserting port in one end of the space, and the guide may have other structures employed.

In this case, the locking hook 127 is structured by forming a C-shaped slit 132 in a connection plate 131 and connecting both side plates 130 in an H shape. An inner side of the slit 132 is arranged so as to protrude towards the engaging portion 128 (which is not limited to an illustrated reentrant portion, but may be constituted by a projection). A locking hook 133 of a magnetically attractable iron piece can cancel the engagement relation with the engaging portion 128 by the locking hook 127 integrally formed with the inserting member 124 and the magnet of the canceling device, at a time of forming the inserting member 124 serving as the locking part 101 by the synthetic resin. However, the structure is not limited to this.

The locking part 101 prevents the display case K′ from being opened (at a time of display), and the locking part 101 (the inserting member 124) is retained at the shop side following the canceling operation.

Accordingly, the display case K′ can be used as the rental case (because the locking piece 101 is not present at a time of lending and the display case K′ is not locked during the lending), and the display case K′ is not left in the shop.

Further, a receiving case E in which a disc is received (which is shipped from the manufacturer) is fitted within the display case K′ mentioned above.

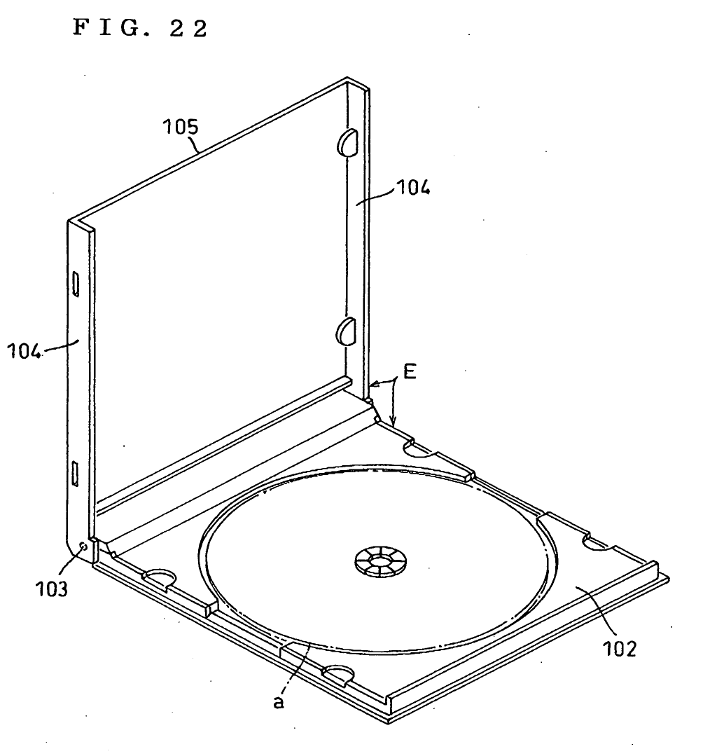

The structure of the receiving case E mentioned above is constituted by the box body 102 for receiving the disc a as shown in FIG. 22. The ends of both the side walls 104 of the lid body 105 are rotatably attached to the ends of both the side walls of the box body 102 via the pin 103. The lid body 105, for example, employs a receiving case for the disc shipped from the manufacturer.

The receiving case E is positioned in the display case K′ by fitting the box body 102 of the receiving case E in the box body 112 of the display case K′such that the hinge of the display case K′ is perpendicular to the hinge of the receiving case E.

The pin 103 side of the hinge of the box body 102 is prevented from escaping the box body 112 by pressing the pin 103 side of the hinge of the box body 102 by a movement preventing means 119 provided in the box body 112, which allows the lid body 105 to be smoothly opened.

In this case, the pressing by the movement preventing means 119 is applied only to the box body 102 side in such a manner as not to obstruct the opening of the lid body 105.

Further, the side wall 117 of the lid body 114 is provided with a window 120 to which a piece of the movement preventing means 119 is fitted at a time of closing the lid body 114, whereby no obstacle is generated at a time of closing the lid body 114.

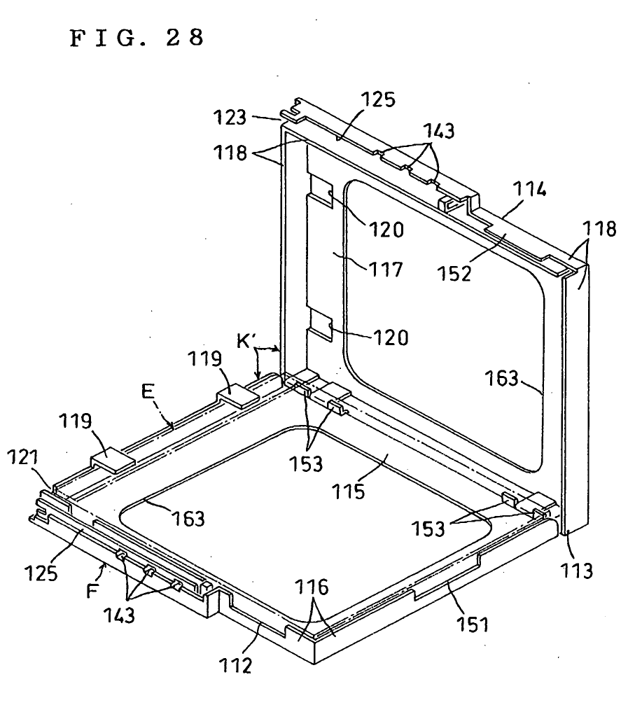

As shown in FIGS. 21 and 28, a lack portion (notched portion) 121 is provided by notching both ends (corner sides) of the peripheral wall 116 positioned in the hinge (the pin 103) side of the receiving case E of the box body 112 from an upper side to a lower side. The side wall 104 of the receiving case E is fitted to the lack portion 121 in accordance with the opening of the lid body 105 of the receiving case E. Due to this feature, a collision between the peripheral wall 116 and the side wall 104 is avoided, and no obstacle is generated at a time of opening the lid body 105.

In accordance with the structure as mentioned above, even if multiple display cases K′ are displayed in parallel in such a manner as to position the lock apparatus F such that it faces the top of the existing shelf T in the shop, as shown in FIG. 31, a front surface of the shelf T and a vertical line directed to a front side of the display case K′ become flush (the flush structure results from the fact that the lock apparatus F is not facing the front side or the rear side of the shelf). In such an arrangement, a sectional capture of a divisional sheet plate P interposed between the sections of the display case K′ is not shielded by the display case K′, and it is not necessary to modify the existing shelf.

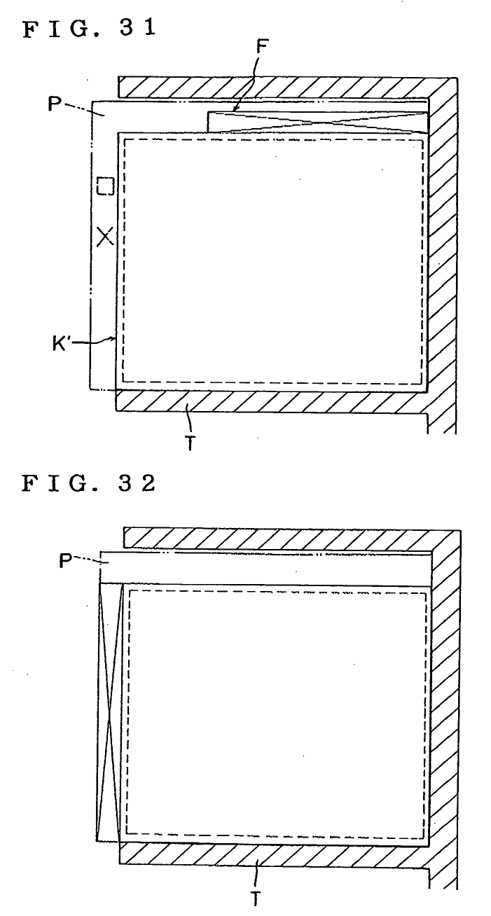

As a result, as shown in FIG. 32, in the event that the display cases are displayed in parallel in the conventional display shelf T in the shop in such a manner that the lock apparatus faces the front side of the shelf, there is no problem caused by the sectional capture of the divisional sheet plate P being shielded by the lock apparatus protruding from the front edge of the shelf T.

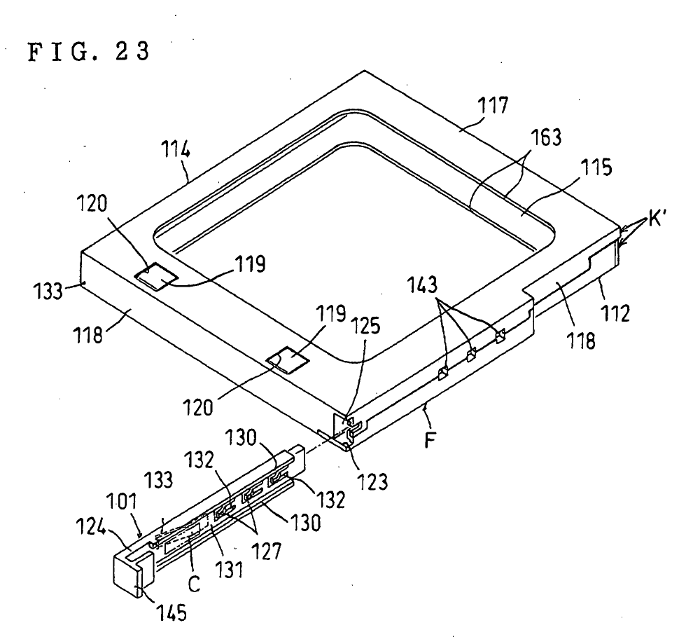

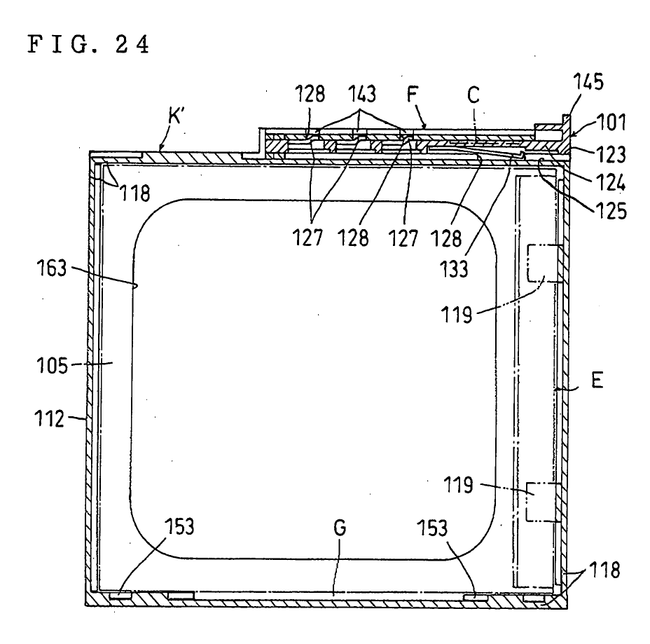

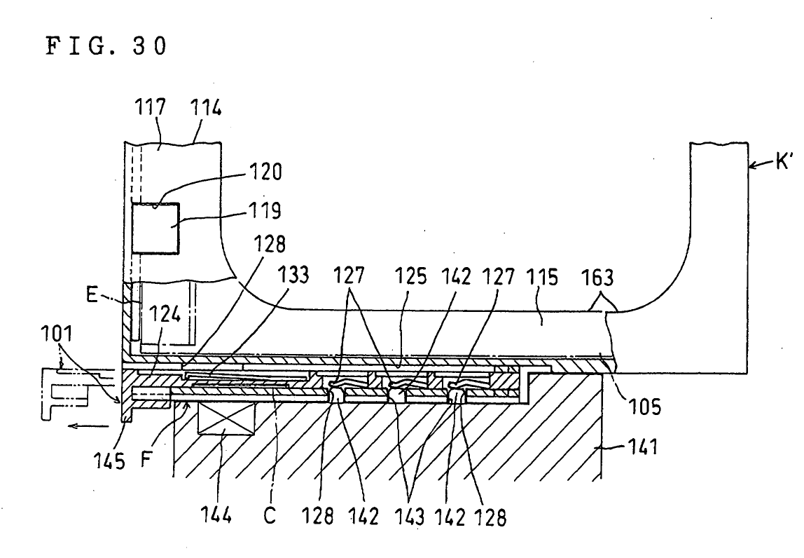

The system shown in FIGS. 23 and 24 which serves as the lock apparatus F mentioned above, is unlocked at the shop side by fitting a protruding shaft 142 of a canceling device 141 into a through hole 143 in which front and back surfaces pass through so as to hold the facing surface of the engaging groove 129 therebetween, as shown in FIG. 30.

Accordingly, the engagement relation between the locking hook 127 and the engaging portion 128 is canceled by pressing back the locking hook 127 brought into contact with the protruding shaft 142.

At the same time, the magnetically attractable locking hook 133 provided in parallel is magnetically attracted by a magnet 144 of the canceling device 141, and cancels the engagement relation of the locking hook 133 with respect to the engaging portion 128.

The inserting member 124 is taken out by catching the fingertip of the user on the protrusion 145 of the inserting member 124 under this condition.

The inserting member 124 of the withdrawn locking part 101 is retained at the shop side.

Further, the locking part 101 is provided with the anti-theft tag C which detects whether the locking part is brought out of the shop.

The tag C mentioned above has, as is well known (for example, Japanese Unexamined Patent Publication No. 2001-122321), a specific ID code, and is structured such that when passing through an entrance of the shop, a resonance circuit resonates on the basis of the generation of a high-frequency electromagnetic field placed at the entrance, and the high-frequency electromagnetic field is modulated in accordance with a transmission of the specific ID code, thereby detecting when the tag is brought out of the shop.

Accordingly, when the lock apparatus F is in the locked state, it is possible to prevent the article displayed in the shelf in the shop from being brought out, and it is not necessary to execute troublesome shielding of the display case K and prepare an article such as a bag or the like due to the recovery of the locking part 101 to the shop at a time of lending the display case K.

The anti-theft tag C mentioned above is not limited to the structure mentioned above, and a seal achieving the same purpose can also be used.

In accordance with a sixth embodiment of the invention, as shown in FIGS. 22, 23, 24 and 28, a desired position of the peripheral wall 116 of the display case K′ is provided with a cut-out portion 151 which is caught on the line edge of the lid body 105 of the receiving case E or is fitted by the fingertip of the user catching the line edge of the lid body 105, at a time of opening the lid body 105 of the receiving case E received in the box body 112.

The cut-out portion 151 mentioned above is formed in both the hinge 113 side of the peripheral wall 116 and the lock apparatus F side, toward the inner side from the edge of the opening 111, and may be provided only in the peripheral wall 116 in any one side of the hinge 113 and the lock apparatus F, or only in the peripheral wall 116 in the side opposing to the movement preventing means 56. In addition, two line edges of the lid body 105 can be caught by a thumb, a first finger or a middle finger of one hand.

Further, if a protruding piece 152 provided in the peripheral wall 118 is structured such that it fits into the cut-out portion 151 at a time of closing the lid body 114 as illustrated, the receiving case E within the display case K′ is not visible from the peripheral surface of the display case K′.

Further, when catching both the peripheral walls 116 in the hinge 113 side and the lock apparatus F side of the display case K′ by the thumb, the first finger or the middle finger of the user's other hand, the peripheral wall 116 is pressed against two opposing lines of the receiving case E on the basis of the pressing force being applied to the inner side by the user, and the lid body 105 is prevented from being smoothly opened due to the pressing force. In this case, it is possible to ensure the smooth opening of the lid body 105 by forming a gap G between the opposing surfaces mentioned above.

The gap G mentioned above is formed by the following means. For example, the peripheral wall 118 of the lid body 114 is fitted into the inner side of the peripheral wall 116 of the box body 112, and the peripheral wall 118 escapes from the inner side of the peripheral wall 116 in accordance with the opening of the lid body 114, whereby the gap G is formed between the peripheral wall 116 and the receiving case E. The gap G can also be formed by the protruding portion 153 being provided in the inner surface peripheral wall 116 side of the side wall 115, and the peripheral wall 116 is pressure contacted with the peripheral surface of the receiving case E by the protruding portion 153.

In accordance with a seventh embodiment of the invention, the display case K′ is provided with a slide down preventing means (slide down stopper) 161 for preventing the receiving case E from sliding down from the box body 112 under the open condition.

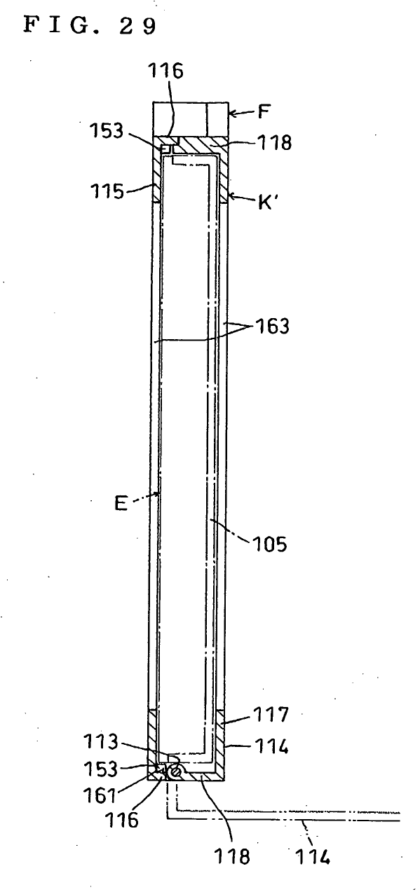

The slide down preventing means (slide down stopper) 161 mentioned above, as shown in FIG. 26, utilizes the peripheral wall 116 of the box body 112 and a protruding portion 153. As shown in FIG. 29, it is possible to receive a part of the peripheral surface of the receiving case E by the peripheral wall 116 having a short protruding length at a time of opening the lid body 114 so as to prevent the sliding down of the receiving case, by making the protruding length of the peripheral wall 116 short, and connecting the peripheral wall 118 having the short protruding length and connected to the side wall 117 of the lid body 114 to the peripheral wall 116 having the short protruding length via the hinge 113.

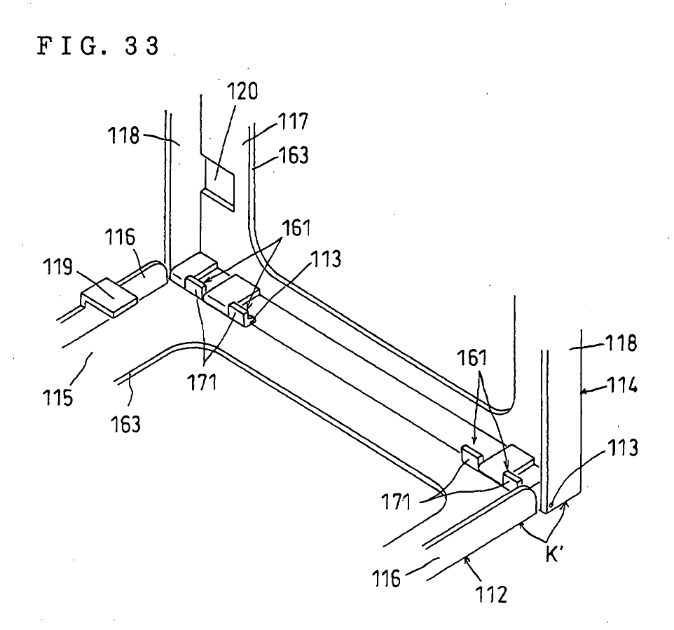

Further, as shown in FIG. 33, the receiving case E is prevented from sliding down by a protruding piece 171 protruding from the inner surface of the side wall 117 and bringing the receiving case E into contact with the protruding piece 171.

In the drawing, reference numeral 163 denotes a through window provided in the side walls 115 and 117.

Further, the hinges of the box body 112 and the lid body 114 constituting the display case K′ can connect the edge of the side wall 115 of the box body 112 to the open edge of the peripheral wall 118 at the lower side of the lid body 114 via the pin hinge 113 so as to freely open and close the display case K′, as shown in FIGS. 22 and 28.

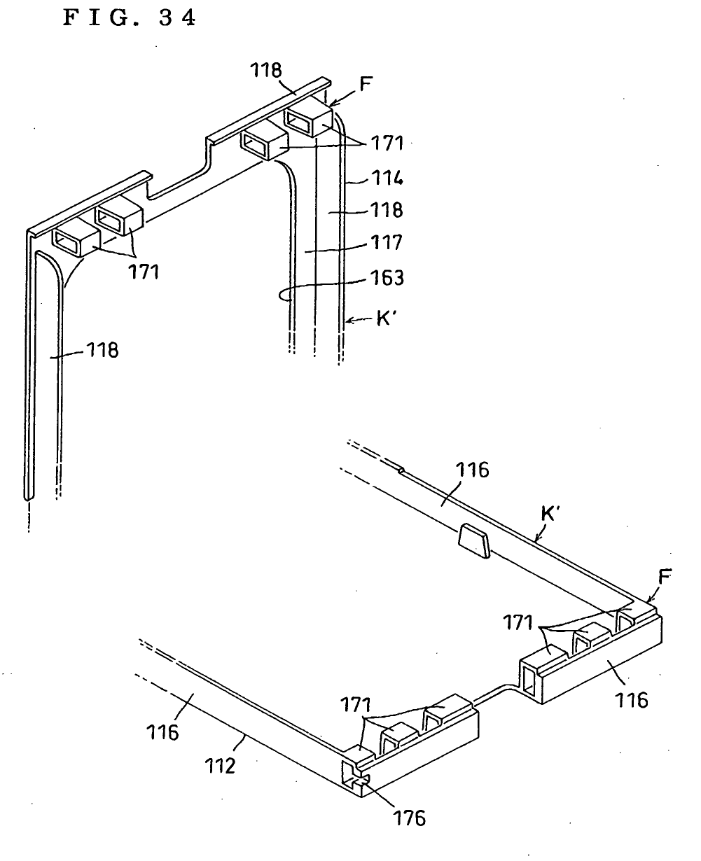

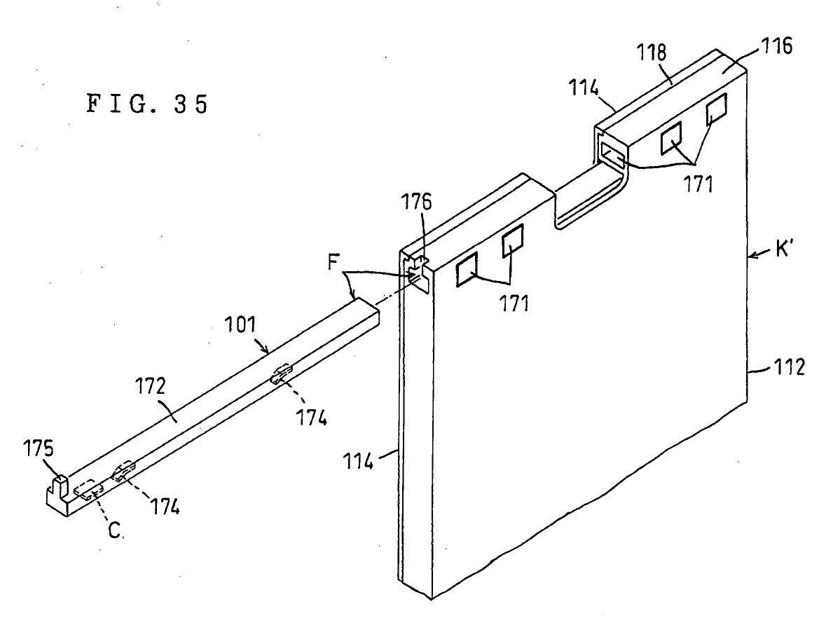

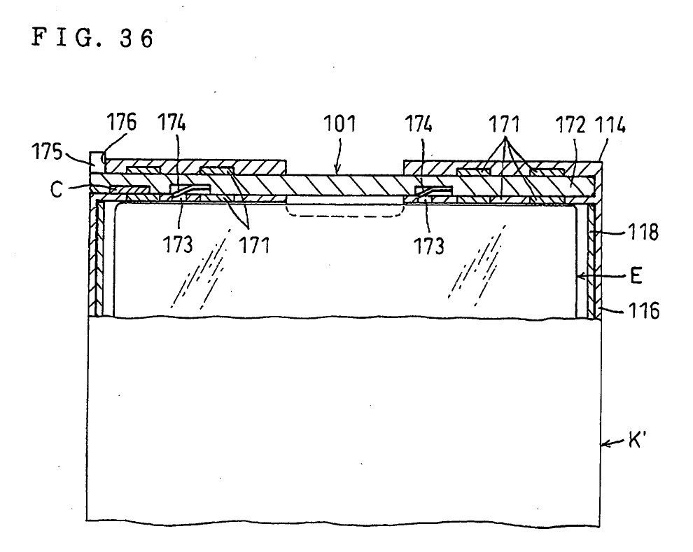

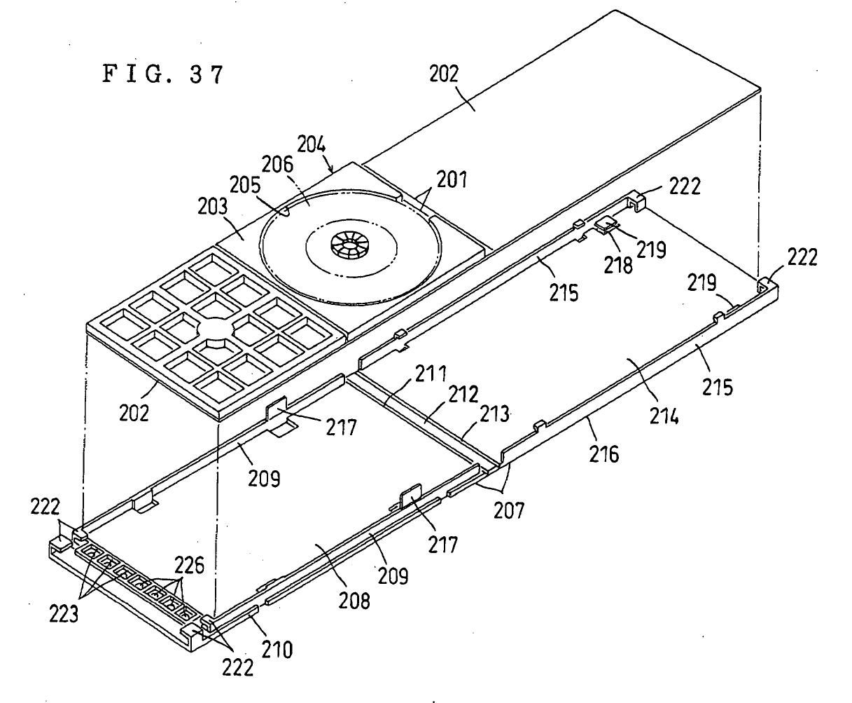

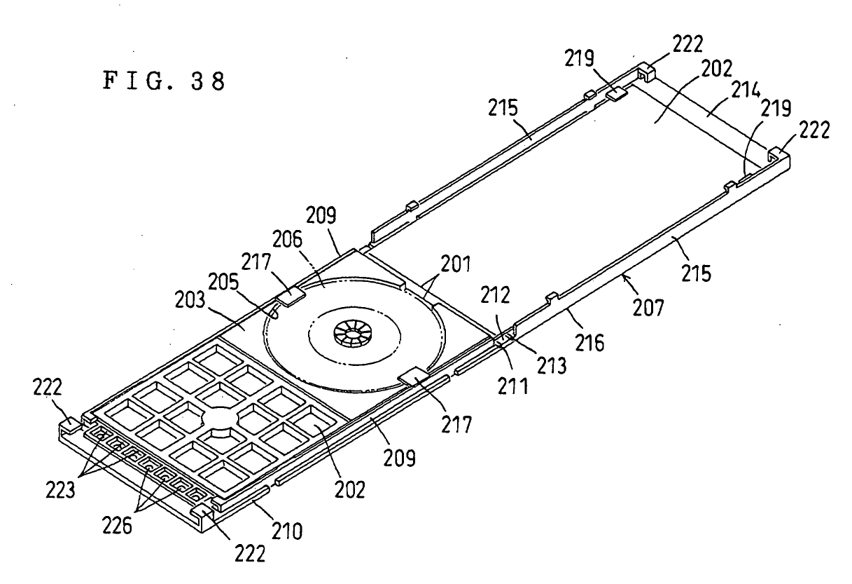

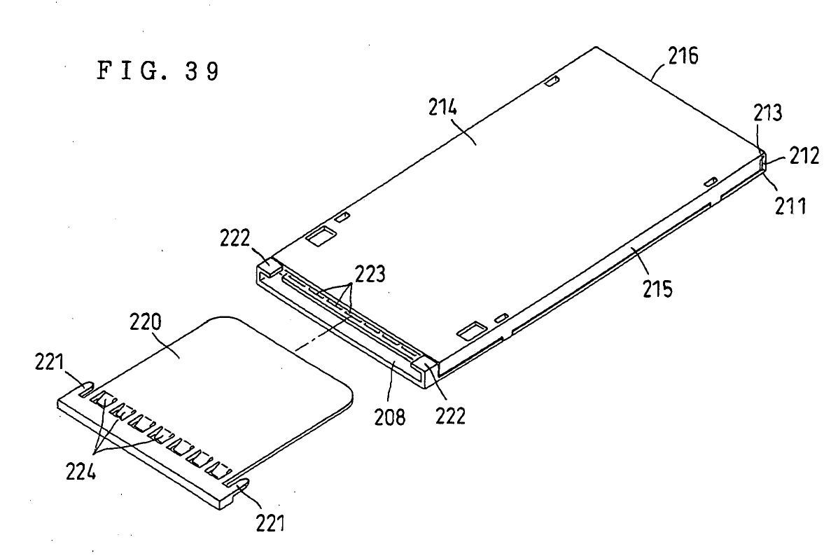

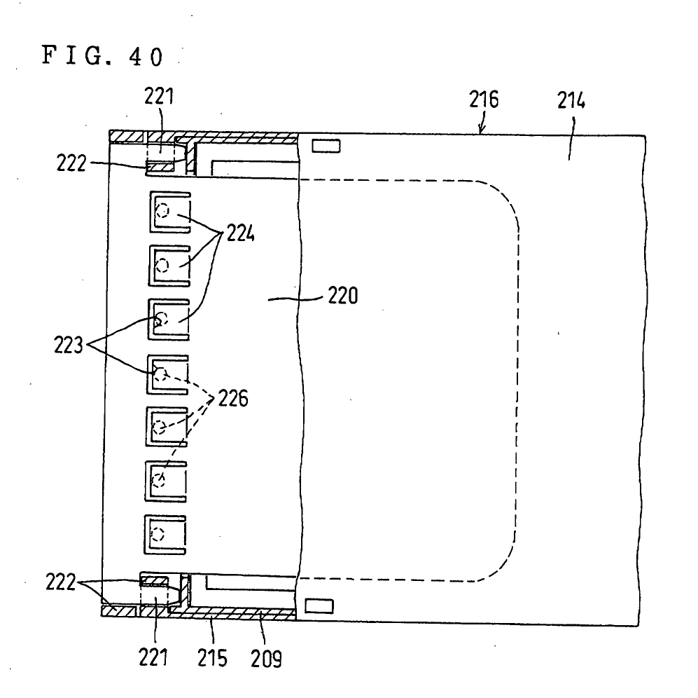

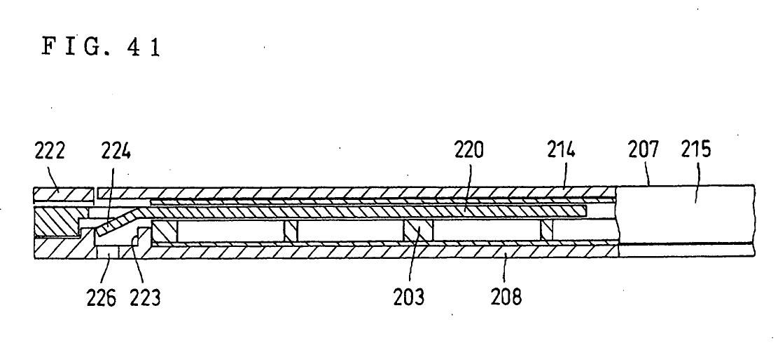

An eighth embodiment of the invention shows another example of the lock apparatus F of the display case K′ in accordance with the fifth to seventh embodiments. As shown in FIGS. 34 to 36, a slider 172 serves as a locking bar so as to prevent the lid body 114 from being opened with respect to the box body 112. This is done by arranging tubular bodies 171 in series in a fitting manner so as to be alternately fitted together in one line of the box body 112 and the lid body 114 under the closed condition, and inserting the slider 172 serving as the locking part 101 to the tubular bodies 171 arranged in series. This prevents the slider 172 from being taken out in in a place other than the shop on the basis of the engagement relation between one locking portion 173 and the other locking hook 174 provided in the opposing surfaces between the slider 172 and the tubular bodies 171 as shown in FIG. 36.

In this case, the engagement relation is structured such that the locking hook 174, which is pressed back against a restoring force during insertion of the slider 172 (i.e., resiliently biased), engages the locking portion 173 in accordance with complete insertion of the slider 172, in the illustrated case. However, the engagement relation can be achieved manually.

The engagement relation is canceled in the shop side and the slider 172 serving as the locking part 101 is retained to the shop side. The engagement relation is canceled by magnetically attracting the locking hook 174 constituted by the iron piece by the magnet, canceling the engagement between the locking hook 174 and the locking portion 173, and removing the slider 172.

An insertion stopper on the slider 172 is formed by a projection 175 protruding from a terminal end of the slider 172 towards an upper side of the display case, which fits into a notch 176 provided in an end edge of the tubular body 171 in one end of the display case. The display case is then unlocked by bringing the projection 175 into contact with the canceling device (not shown) including the magnet, and thereafter sliding the canceling device while holding the display case K′, or sliding the display case K′ while holding the canceling device. Accordingly, the slider 172 can be withdrawn on the basis of the catch of the projection 175.

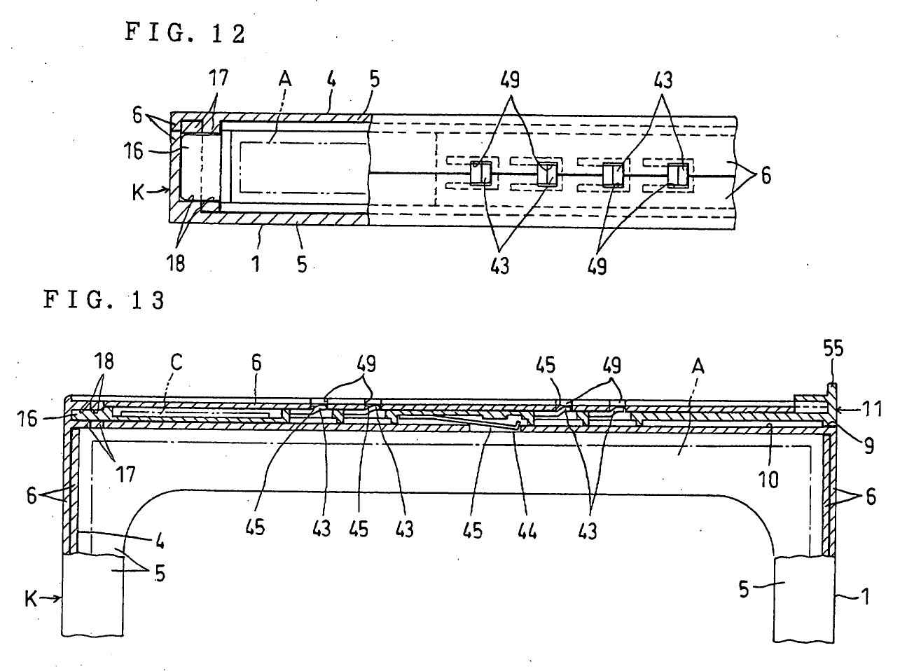

Of course, the canceling device is not limited to the magnet system, but can employ a system of canceling the engagement relation between the locking hook and the engaging portion while pressing the projection or the protruding shaft of the canceling device in the shop side so as to press back the locking hook, or a system shown in FIG. 12 of Japanese Patent Application No. 2002-115435, for example.

In addition to the lock apparatus F mentioned above, the structure may be made, for example, such that the tubular body is provided in one of both the peripheral walls 116 and 118 of the box body 112 and the lid body 114, an L-shaped hook piece is provided in the other peripheral wall, and a hook piece is fitted into the tubular body from the through window of the tubular body in accordance with the closing of the display case K′ whereby the hook piece is caught on the slider by inserting the slider serving as the locking part so as to maintain the closed state of the display case K′.

The locking portion and the locking hook forming the same engagement relation as mentioned above are provided in opposing surfaces of the slider and the tubular body or the hook piece.

In this case, as in the other structures of the lock apparatus F, it is possible to appropriately select and employ a structure in Japanese Unexamined Patent Publication No. 2000-142863, a structure in Japanese Unexamined Patent Publication No. 2001-2101, a structure in Japanese Unexamined Patent Publication No. 2001-331877 and the like. Further, the locking system in correspondence to the structure is used.

In short, the structure may be made as long as the display case K′ is closed in a state of putting the receiving case A of the disc a in the display case K, the lock apparatus F is locked in the shop side, and the locking part 101 is retained at the shop side in accordance with the unlocking of the lock apparatus F in the shop side at a time of lending.

As a result, since the locking part 101 is not present in the display case K when it is rented, the display case K is not locked at a time of handling.

1-8. (canceled)

9. An anti-theft apparatus comprising:
a display case including a box body and a lid body connected to a side of said box body via a hinge so as to be operable to open and close an opening of said box body, said display case having:
a guide with an insertion port; and
an engaging portion; and
an inserting member to be inserted into said guide via said insertion port so as to thereby prevent said display case from being opened, said inserting member having:
a resilient retaining hook operable to generate a restoring force when pressed back during insertion of said inserting member into said guide, said retaining hook being operable to engage said engaging portion of said display case due to said restoring force when said inserting member is fully inserted into said guide, said retaining hook being at least partially metallic so as to be magnetically attractable by a magnet; and
a stopper for limiting movement of said retaining hook when said retaining hook is attracted by the magnet so as to inhibit said retaining hook from contacting an inner surface of said display case.

10. The anti-theft apparatus of claim 9, wherein said inserting member has an anti-theft tag.

11. The anti-theft apparatus of claim 9, wherein said retaining hook is only partially metallic.

12. The anti-theft apparatus of claim 9, wherein said inserting member has a plurality of retaining hooks arranged along a direction of insertion of said inserting member into said guide, each of said retaining hooks being operable to be pressed back against a restoring force during insertion of said inserting member into said guide and being operable to engage said engaging portion of said display case due to said restoring force when said inserting member is fully inserted into said guide.

13. The anti-theft apparatus of claim 9, wherein said inserting member is formed of resin, said retaining hook having a main body formed of resin so as to be integral with said resin inserting member, said retaining hook including a metallic iron piece attached thereto.

14. The anti-theft apparatus of claim 9, wherein said resilient retaining hook is shaped and arranged to retain said inserting member in said guide when said inserting member is fully inserted into said guide.

15. An anti-theft apparatus comprising:
a display case including a box body and a lid body connected to a side of said box body via a hinge so as to be operable to open and close an opening of said box body, said display case having:
a guide with an insertion port;
a first engaging portion;
a second engaging portion; and
a through-hole; and
an inserting member to be inserted into said guide via said insertion port so as to thereby prevent said display case from being opened, said inserting member having:
a magnetically attractable first resilient retaining hook operable to generate a first restoring force when pressed back during insertion of said inserting member into said guide, said first retaining hook being operable to engage said first engaging portion of said display case due to said first restoring force when said inserting member is fully inserted into said guide; and
a non-magnetic second resilient retaining hook operable to generate a second restoring force when pressed back during insertion of said inserting member into said guide, said second retaining hook being operable to engage said second engaging portion of said display case due to said second restoring force when said inserting member is fully inserted into said guide;
wherein said through-hole is aligned with said second retaining hook and said second engaging portion when said inserting member is fully inserted into said guide, said through-hole being shaped to allow a protruding shaft to pass therethrough to disengage said second retaining hook from said second engaging portion.

16. The anti-theft apparatus of claim 15, wherein said inserting member is formed of resin, said first and second retaining hooks having a main body formed of resin so as to be integral with said resin inserting member, said first retaining hook including a metallic iron piece attached thereto.

17. The anti-theft apparatus of claim 15, wherein said magnetically attractable first resilient retaining hook and said non-magnetic second resilient retaining hook are shaped and arranged to retain said inserting member in said guide when said inserting member is fully inserted into said guide.

18. A display system comprising:
an anti-theft object for receiving an article, said anti-theft object having:
a guide with an insertion port;
a first engaging portion;
a second engaging portion; and
a through-hole; and
an inserting member to be inserted into said guide via said insertion port, said inserting member having:
a magnetically attractable first resilient retaining hook operable to generate a first restoring force when pressed back during insertion of said inserting member into said guide, said first retaining hook being operable to engage said first engaging portion of said anti-theft subject due to said first restoring force when said inserting member is fully inserted into said guide;
a non-magnetic second resilient retaining hook operable to generate a second restoring force when pressed back during insertion of said inserting member into said guide, said second retaining hook being operable to engage said second engaging portion of said anti-theft subject due to said second restoring force when said inserting member is fully inserted into said guide; and
an anti-theft tag;
wherein said through-hole is aligned with said second retaining hook and said second engaging portion when said inserting member is fully inserted into said guide, said through-hole being shaped to allow a protruding shaft to pass therethrough to disengage said second retaining hook from said second engaging portion.

19. The display system of claim 18, wherein said inserting member is formed of resin, said first and second retaining hooks having a main body formed of resin so as to be integral with said resin inserting member, said first retaining hook including a metallic iron piece attached thereto.

20. An anti-theft apparatus comprising:
a display case including a first box body and a first lid body connected to a lower side of said first box body via a first hinge so as to be operable to open and close an opening of said first box body;
a lock apparatus at an upper side of said first box body and said first lid body, said lock apparatus including a removable locking part for locking said display case; and
a receiving case including a second box body for receiving a commodity and a second lid body connected to a side of said second box body via a second hinge so as to be operable to open and close an opening of said second box body, wherein said display case and said receiving case are shaped and arranged such that said first hinge of said display case and said second hinge of said receiving case are perpendicular to each other when said receiving case is fitted within said display case.

21. The anti-theft apparatus of claim 20, wherein a fingertip-fitting indentation is formed in a peripheral wall of said first box body of said display case.

22. The anti-theft apparatus of claim 20, wherein said display case has a slide down stopper at said lower side of said display case, said slide down stopper being arranged to support said receiving case when the display case is open.

23. The anti-theft apparatus of claim 20, wherein said locking part of said lock apparatus has an anti-theft tag.

24. The anti-theft apparatus of claim 20, wherein said display case has a movement stopping member at a lateral side of said display case, said movement stopping member being arranged to receive said second box body of said receiving case for securing said receiving case within said display case.

25. The anti-theft apparatus of claim 20, wherein said lock apparatus further includes:
a guide in said display case, said guide having an insertion port;
a first engaging portion; and
a second engaging portion, wherein said locking part comprises an inserting member to be inserted into said guide via said insertion port, said inserting member having:
a magnetically attractable first resilient retaining hook operable to generate a first restoring force when pressed back during insertion of said inserting member into said guide, said first retaining hook being operable to engage said first engaging portion of said lock apparatus due to said first restoring force when said inserting member is fully inserted into said guide; and
a non-magnetic second resilient retaining hook operable to generate a second restoring force when pressed back during insertion of said inserting member into said guide, said second retaining hook being operable to engage said second engaging portion of said lock apparatus due to said second restoring force when said inserting member is fully inserted into said guide.
